(19) United States
(12) Patent Application Publication
(10) Pub. No.: US 2026/0172730 A1
(43) Pub. Date: Jun. 18, 2026

(54) ACOUSTIC SIGNAL OUTPUT DEVICE

(71) Applicant: NTT, Inc., Tokyo (JP)

(72) Inventors: Tatsuya KAKO, Musashino-shi, Tokyo (JP); Hironobu CHIBA, Musashino-shi, Tokyo (JP)

(73) Assignee: NTT, Inc., Tokyo (JP)

(21) Appl. No.: 19/124,915

(22) PCT Filed: Nov. 10, 2022
(86) PCT No.: PCT/JP2022/041811

§ 371 Date: Apr. 28, 2025

(51) Int. Cl. H04R 1/10

(52) U.S. Cl. CPC H04R 1/10

(57) ABSTRACT

An acoustic signal output device including a structure including a single or a plurality of first sound holes that emits a first acoustic signal to an outside, a hollow portion having an internal space into which a second acoustic signal is emitted, and a single or a plurality of second sound holes that emits the second acoustic signal emitted to the internal space of the hollow portion to the outside. Further, there is a single or a plurality of mechanisms to change at least one of an opening area of the first sound hole or the second sound hole, a length from the internal space of the hollow portion to an opening end of the first sound hole or the second sound hole, or a volume of the internal space of the hollow portion.

### TECHNICAL FIELD

The present invention relates to an acoustic signal output device, and particularly relates to an acoustic signal output device that does not seal an ear canal.

### BACKGROUND ART

In recent years, an increase in burden on ears due to wearing of earphones and a headphone has been an issue. As devices that reduce a burden on ears, open-ear (open-type) earphones and headphones that do not block ear canals are known.

### CITATION LIST

### Non Patent Literature

Non Patent Literature 1: “WHAT ARE OPEN-EAR HEADPHONES?”, [online], Bose Corporation, [searched on Sep. 13, 2021], the Internet <https://www.bose.com/en_us/better_with bose/open-ear-headphones.html>

### SUMMARY OF INVENTION

### Technical Problem

However, open-ear earphones and headphones have an issue that sound leakage to the surroundings is large. Such an issue is not limited to the open-ear earphones and headphones, but is an issue common to acoustic signal output devices that do not seal ear canals, including installation-type and embedded-type speakers.

The present invention has been made in view of such a point, and an object of the present invention is to provide an acoustic signal output device that does not seal an ear canal and is capable of reducing sound leakage to the surroundings.

### Solution to Problem

Provided is an acoustic signal output device including: a structure unit provided with a single or a plurality of first sound holes that emits a first acoustic signal to an outside, a hollow portion having an internal space into which a second acoustic signal is emitted, and a single or a plurality of second sound holes that emits the second acoustic signal emitted to the internal space of the hollow portion to the outside; and a single or a plurality of mechanism units configured to change at least one of an opening area of the first sound hole or the second sound hole, a length from the internal space of the hollow portion to an opening end of the first sound hole or the second sound hole, or a volume of the internal space of the hollow portion. In the acoustic signal output device, an attenuation rate of the first acoustic signal at a second point with reference to a predetermined first point where the first acoustic signal arrives, the second point being farther from the acoustic signal output device than the first point, in a case where the first acoustic signal is emitted from the first sound hole and the second acoustic signal is emitted from the second sound hole, is designed to be equal to or less than a predetermined value smaller than an attenuation rate due to air propagation of an acoustic signal at the second point with reference to the first point. Alternatively, in the acoustic signal output device, in this case, an attenuation amount of the first acoustic signal at the second point with reference to the first point is designed to be equal to or larger than a predetermined value larger than an attenuation amount due to air propagation of an acoustic signal at the second point with reference to the first point.

### Advantageous Effects of Invention

Thereby, it is possible to suppress the sound leakage to the surroundings.

### BRIEF DESCRIPTION OF DRAWINGS

FIG. 1 is a transparent perspective view illustrating a configuration of an acoustic signal output device according to a first embodiment.

FIG. 2A is a transparent plan view illustrating the configuration of the acoustic signal output device according to the first embodiment. FIG. 2B is a transparent front view illustrating the configuration of the acoustic signal output device according to the first embodiment. FIG. 2C is a bottom view illustrating the configuration of the acoustic signal output device according to the first embodiment.

FIG. 3A is an end view taken along line 2BA-2BA in FIG. 2B. FIG. 3B is an end view taken along line 2A-2A in FIG. 2A. FIG. 3C is an end view taken along line 2BC-2BC in FIG. 2B.

FIG. 4 is a conceptual view for illustrating arrangement of sound holes.

FIG. 5A is a view for illustrating a use state of the acoustic signal output device according to the first embodiment. FIG. 5B is a view for illustrating an observation condition of an acoustic signal emitted from the acoustic signal output device according to the first embodiment.

FIG. 6 is a graph illustrating frequency characteristics of acoustic signals observed at a position P1 in FIG. 5B.

FIG. 7 is a graph illustrating frequency characteristics of acoustic signals observed at a position P2 in FIG. 5B.

FIG. 8 is a graph illustrating differences between the acoustic signals observed at the position P1 and the acoustic signals observed at the position P2.

FIGS. 9A and 9B are graphs each illustrating a relationship between an area ratio of sound holes and sound leakage.

FIG. 10A is a front view for illustrating arrangement of sound holes. FIG. 10B is a conceptual view for illustrating the arrangement of sound holes.

FIG. 11A is a front view for illustrating arrangement of sound holes. FIG. 11B is a conceptual view for illustrating the arrangement of sound holes.

FIGS. 12A to 12C are front views for illustrating modifications of the arrangement of sound holes.

FIGS. 13A and 13B are transparent plan views for illustrating the modifications of the arrangement of sound holes.

FIGS. 14A and 14B are conceptual views for illustrating the modifications of the arrangement of sound holes.

FIG. 15A is a graph illustrating a relationship between an acoustic signal AC1 (positive-phase signal) emitted from a first sound hole to the outside and an acoustic signal AC2 (negative-phase signal) emitted from second sound holes to the outside. FIG. 15B is a graph for illustrating a relationship between a phase difference between the acoustic signal AC1 (positive-phase signal) emitted from the first sound hole to the outside and the acoustic signal AC2 (negative-phase signal) emitted from the second sound holes to the outside and the frequencies of the acoustic signals AC1 and AC2 in a case where a distance between the first sound hole and the second sound holes is 1.5 cm. FIG. 15C is a graph for illustrating a relationship between the maximum value of a sum of the magnitude of the acoustic signal AC1 (positive-phase signal) and the acoustic signal AC2 (negative-phase signal) observed at a position 15 cm outside the acoustic signal output device and the frequencies of the acoustic signals AC1 and AC2 in a case where a distance between the first sound hole and the second sound holes is 1.5 cm.

FIG. 16A is a diagram for illustrating a state in which the acoustic signal output device is modeled as an enclosure. FIG. 16B is a graph for illustrating a relationship between a resonance frequency f_{H} [Hz] determined on the basis of the Helmholtz resonance of the enclosure and the magnitude of the acoustic signal AC2 (negative-phase signal) in the housing. FIG. 16C is a graph for illustrating a relationship between a difference between the phase of the acoustic signal AC2 (negative-phase signal) emitted from the second sound holes to the outside and the phase of the acoustic signal AC2 (negative-phase signal) emitted from the driver unit, and the frequency of the acoustic signal AC2 (negative-phase signal).

FIG. 17A is a conceptual diagram for describing states of the acoustic signals AC1 and AC2 observed at the position P2. FIG. 17B is a graph for illustrating a relationship between a phase difference between the acoustic signal AC1 (positive-phase signal) emitted from the first sound hole to the outside and the acoustic signal AC2 (negative-phase signal) emitted from the second sound holes to the outside and the frequencies of the acoustic signals AC1 and AC2 in a case where a distance between the first sound hole and the second sound holes is 1.5 cm and the resonance frequency f_{H} [Hz] determined on the basis of the Helmholtz resonance of the enclosure is appropriately adjusted. FIG. 17C is a graph for illustrating a relationship between the maximum value of a sum of the magnitude of the acoustic signal AC1 (positive-phase signal) and the acoustic signal AC2 (negative-phase signal) observed at a position 15 cm outside the acoustic signal output device and the frequencies of the acoustic signals AC1 and AC2 in a case where a distance between the first sound hole and the second sound holes is 1.5 cm and the resonance frequency f_{H} [Hz] determined on the basis of the Helmholtz resonance of the enclosure is appropriately adjusted.

FIG. 18A is a diagram in which a relationship between the first sound hole, the second sound holes, and the position P2 is modeled. In this example, the first sound hole and the second sound holes are separated from each other by a distance Dₚₙ. FIG. 18B is a graph for illustrating a relationship between a phase difference and the frequencies of the acoustic signals AC1 and AC2 observed at the position P2 in a case where a delay φ_{c} for reducing a phase difference between the acoustic signal AC1 and the acoustic signal AC2 at P2 is given to the acoustic signal AC2 (with φ_{c}) and in a case where the delay φ_{c} is not given to the acoustic signal AC2 (without φ_{c}).

FIG. 19A is a conceptual diagram for describing states of the acoustic signals AC1 and AC2 observed at the position P2. FIG. 19B is a graph illustrating a relationship between a frequency and a phase characteristic.

FIG. 20A is a graph in which frequency characteristics of acoustic signals observed at the position P1 in FIG. 5B are compared for acoustic signal output devices having different sums of opening areas of sound holes. FIG. 20B is a graph in which frequency characteristics of acoustic signals observed at the position P2 in FIG. 5B are illustrated for the acoustic signal output devices having different sums of opening areas of sound holes. FIG. 20C is a graph in which a difference between an acoustic signal observed at the position P1 and an acoustic signal observed at the position P2 is illustrated for the acoustic signal output devices having different sums of opening areas of sound holes.

FIG. 21A is a graph in which frequency characteristics of acoustic signals observed at the position P1 in FIG. 5B are compared for acoustic signal output devices having different volumes of an internal space of the housing. FIG. 21B is a graph in which frequency characteristics of acoustic signals observed at the position P2 in FIG. 5B are illustrated for the acoustic signal output devices having different volumes of an internal space of the housing. FIG. 21C is a graph in which a difference between an acoustic signal observed at the position P1 and an acoustic signal observed at the position P2 is illustrated for the acoustic signal output devices having different volumes of an internal space of the housing.

FIG. 22A is a graph in which frequency characteristics of acoustic signals observed at the position P1 in FIG. 5B are compared for an acoustic signal output device of the embodiment (reference: with enclosure) and an open acoustic signal output device (without enclosure). FIG. 22B is a graph in which frequency characteristics of acoustic signals observed at the position P2 in FIG. 5B are illustrated for the acoustic signal output device of the embodiment and the open acoustic signal output device. FIG. 22C is a graph in which a difference between an acoustic signal observed at the position P1 and an acoustic signal observed at the position P2 is illustrated for the acoustic signal output device of the embodiment and the open acoustic signal output device.

FIGS. 23A to 23C are end views taken along line 2A-2A in FIG. 2A according to a second embodiment.

FIGS. 24A to 24C are end views taken along line 2A-2A in FIG. 2A according to the second embodiment.

FIGS. 25A to 25C are end views taken along line 2A-2A in FIG. 2A according to the second embodiment.

FIG. 26 is a perspective view illustrating a configuration of an acoustic signal output device according to a third embodiment.

FIG. 27 is a transparent plan view illustrating the configuration of the acoustic signal output device according to the third embodiment. FIG. 27B is a transparent front view illustrating the configuration of the acoustic signal output device according to the third embodiment.

FIG. 28A is an end view taken along line 27BA-27BA in FIG. 27B. FIG. 28B is an end view taken along line 27A-27A in FIG. 27A.

FIGS. 29A and 29B are conceptual views for illustrating arrangement of sound holes.

FIG. 30 is a view for illustrating a use state of the acoustic signal output device according to the third embodiment.

FIGS. 31A to 31C are end views taken along line 27A-27A in FIG. 27A according to a fourth embodiment.

FIGS. 32A and 32B are graphs illustrating frequency characteristics of acoustic signals emitted from the acoustic signal output device.

FIG. 33 is a transparent plan view illustrating a configuration of an acoustic signal output device according to a fifth embodiment. FIG. 33B is a transparent front view illustrating the configuration of the acoustic signal output device according to the fifth embodiment.

FIGS. 34A to 34C are cross-sectional views taken along line 33A-33A in FIG. 33A.

FIG. 35 is a graph illustrating frequency characteristics of an inside of a housing calculated on the basis of a volume, a neck length, and an opening area of the inside of the housing.

### DESCRIPTION OF EMBODIMENTS

Hereinafter, embodiments of the present invention will be described with reference to the drawings.

### First Embodiment

First, a first embodiment of the present invention will be described.

### <Configuration>

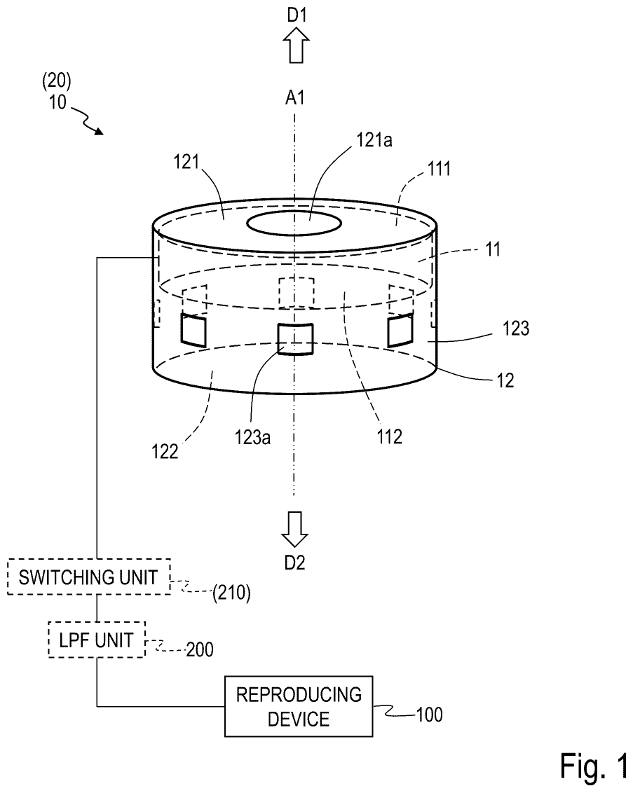

An acoustic signal output device 10 of the present embodiment is an acoustic listening device (for example, open-ear (open) earphone, headphone, an installation-type speaker, an embedded-type speaker, or the like) that is worn without sealing an ear canal of a user. As illustrated in FIGS. 1, 2A to 2C, and 3A to 3C, the acoustic signal output device 10 of the present embodiment includes a driver unit 11 that converts an output signal (electrical signal representing an acoustic signal) output from a reproducing device 100 into an acoustic signal and outputs the acoustic signal, and a housing 12 that internally accommodates the driver unit 11.

### <Driver Unit 11>

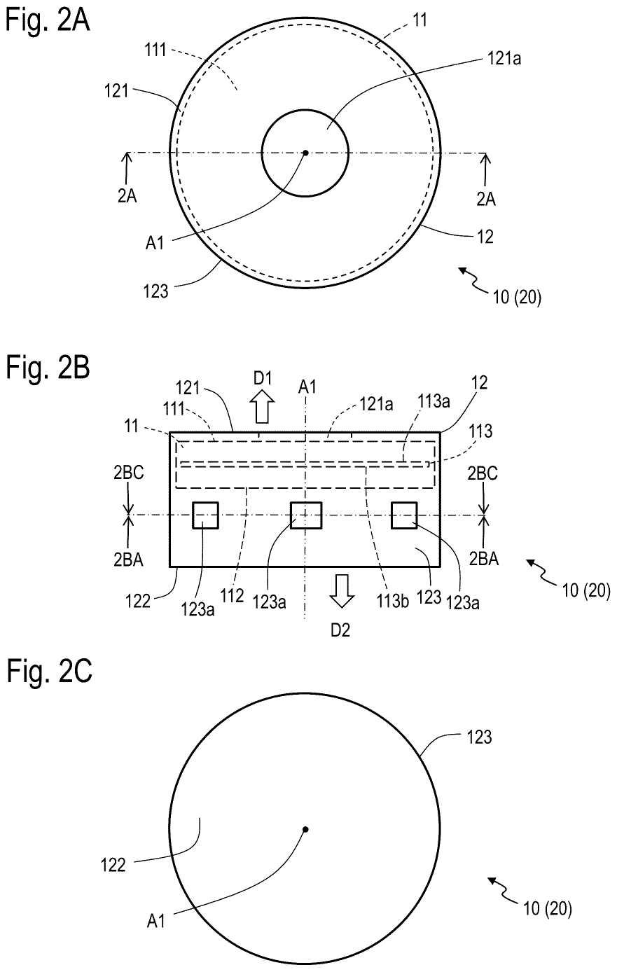

The driver unit (speaker driver unit or driver) 11 is a device (device including a speaker function) that emits (emits sound of) an acoustic signal AC1 (first acoustic signal) based on an input output signal to one side (D1 direction side), and emits an acoustic signal AC2 (second acoustic signal) that is an antiphase signal (phase inversion signal) of the acoustic signal AC1 or an approximate signal of the antiphase signal to the other side (D2 direction side). That is, an acoustic signal emitted from the driver unit 11 to one side (D1 direction side) is referred to as the acoustic signal AC1 (first acoustic signal), and an acoustic signal emitted from the driver unit 11 to the other side (D2 direction side) is referred to as the acoustic signal AC2 (second acoustic signal). For example, the driver unit 11 includes a diaphragm 113 that emits the acoustic signal AC1 from one surface 113a to the D1 direction side by vibration, and emits the acoustic signal AC2 from the other surface 113b to the D2 direction side by this vibration (FIG. 2B). By the diaphragm 113 vibrating on the basis of an input output signal, the driver unit 11 of this example emits the acoustic signal AC1 from a one side surface 111 to the D1 direction side, and emits the acoustic signal AC2 that is an antiphase signal of the acoustic signal AC1 or an approximate signal of the antiphase signal from the other side 112 to the D2 direction side. That is, the acoustic signal AC2 is secondarily emitted along with emission of the acoustic signal AC1. Note that the D2 direction (other side) is, for example, the opposite direction of the D1 direction (one side), but the D2 direction does not need to be strictly the opposite direction of the D1 direction, and the D2 direction is only required to be different from the D1 direction. The relationship between one side (D1 direction) and the other side (D2 direction) depends on the type and shape of the driver unit 11. Furthermore, depending on the type and shape of the driver unit 11, the acoustic signal AC2 may strictly be an antiphase signal of the acoustic signal AC1, or the acoustic signal AC2 may be an approximate signal of the antiphase signal of the acoustic signal AC1. For example, the approximate signal of the antiphase signal of the acoustic signal AC1 may be (1) a signal obtained by shifting the phase of the antiphase signal of the acoustic signal AC1, (2) a signal obtained by changing (amplifying or attenuating) the amplitude of the antiphase signal of the acoustic signal AC1, or (3) a signal obtained by shifting the phase of the antiphase signal of the acoustic signal AC1 and further changing the amplitude. A phase difference between the antiphase signal of the acoustic signal AC1 and the approximate signal thereof is desirably smaller than or equal to d1% of one period of the antiphase signal of the acoustic signal AC1. Examples of 81% include 1%, 3%, 5%, 10%, and 20%. A difference between the amplitude of the antiphase signal of the acoustic signal AC1 and the amplitude of the approximate signal thereof is desirably smaller than or equal to 02% of the amplitude of the antiphase signal of the acoustic signal AC1. Examples of 82% include 1%, 3%, 5%, 10%, and 20%. Note that examples of the type of the driver unit 11 include a dynamic type, a balanced armature type, a hybrid type of the dynamic type and the balanced armature type, and a capacitor type. The shapes of the driver unit 11 and the diaphragm 113 are any shape. In the present embodiment, for simplification of description, an example in which the outer shape of the driver unit 11 is a substantially cylindrical shape including both end surfaces and the diaphragm 113 is a substantially disk shape is described, but this does not limit the present invention. For example, the outer shape of the driver unit 11 may be a rectangular parallelepiped shape or the like, and the diaphragm 113 may be a dome shape or the like. Examples of an acoustic signal are sound such as music, sound, a sound effect, and environmental sound.

### <Housing 12>

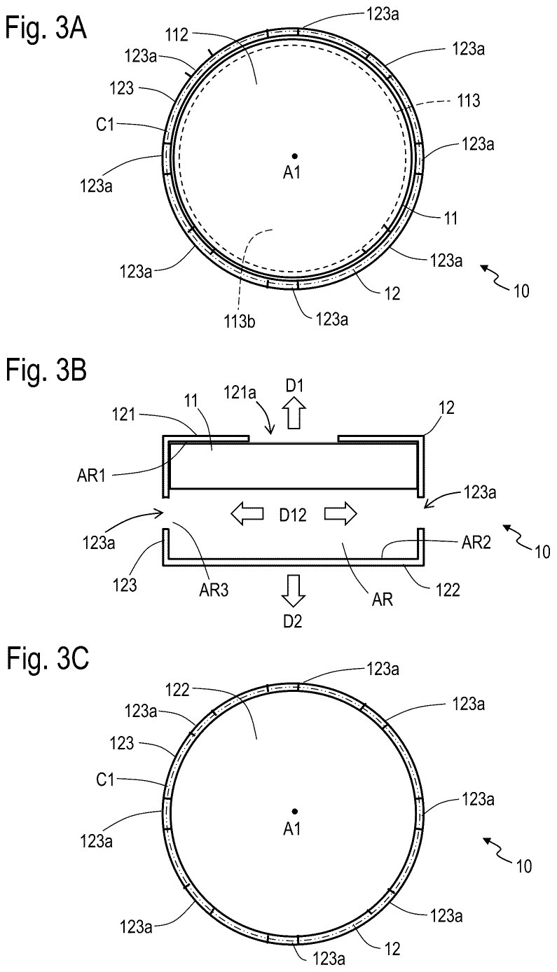

The housing 12 is a hollow member including a wall portion on the outer side, and internally houses the driver unit 11. For example, the driver unit 11 is fixed to an end portion on the D1 direction side inside the housing 12. However, this does not limit the present invention. Although the shape of the housing 12 is also any shape, for example, the shape of the housing 12 is desirably rotationally symmetric (line-symmetric) or substantially rotationally symmetric about an axis A1 extending along the D1 direction. As a result, including sound holes 123a (details will be described below) such that variation in the energy of sound emitted from the housing 12 depending on the direction is reduced is facilitated. As a result, sound leakage can be easily reduced uniformly in each direction. For example, the housing 12 includes a first end surface that is a wall portion 121 arranged on one side (D1 direction side) of the driver unit 11, a second end surface that is a wall portion 122 arranged on the other side (D2 direction side) of the driver unit 11, and a side surface that is a wall portion 123 surrounding a space sandwiched between the first end surface and the second end surface around the axis A1 passing through the first end surface and the second end surface (FIG. 2B, FIG. 3B). In the present embodiment, for simplification of description, an example is described in which the housing 12 has a substantially cylindrical shape including both end surfaces. For example, the interval between the wall portion 121 and the wall portion 122 is 10 mm, and the wall portions 121, 122 each have a circular shape having a radius of 10 mm. However, this is an example and does not limit the present invention. For example, the housing 12 may have a substantially dome shape including a wall portion at an end portion, or may have a hollow substantially cubic shape, or may have another three-dimensional shape. The material of the housing 12 is any material. The housing 12 may be formed from a rigid body such as synthetic resin or metal, or may be formed from an elastic body such as rubber.

<Sound Holes 121a and 123a>

The wall portion of the housing 12 includes a sound hole 121a (first sound hole) for leading out the acoustic signal AC1 (first acoustic signal) emitted from the driver unit 11 to the outside and sound holes 123a (second sound holes) for leading out the acoustic signal AC2 (second acoustic signal) emitted from the driver unit 11 to the outside. The sound hole 121a and the sound holes 123a are, for example, through holes penetrating the wall portion of the housing 12, but this does not limit the present invention. As long as the acoustic signal AC1 and the acoustic signal AC2 can be led out to the outside, the sound hole 121a and the sound holes 123a may not be through holes.

The acoustic signal AC1 emitted from the sound hole 121a reaches the ear canal of the user and is heard by the user. On the other hand, the acoustic signal AC2 that is an antiphase signal of the acoustic signal AC1 or an approximate signal of the antiphase signal is emitted from the sound holes 123a. A part of the acoustic signal AC2 cancels out a part (sound leakage component) of the acoustic signal AC1 emitted from the sound hole 121a. That is, by the acoustic signal AC1 (first acoustic signal) being emitted from the sound hole 121a (first sound hole) and the acoustic signal AC2 (second acoustic signal) being emitted from the sound holes 123a (second sound holes), an attenuation rate nu of the acoustic signal AC1 (first acoustic signal) at a position P2 (second point) with reference to a position P1 (first point) can be set to be less than or equal to a predetermined value ηₜₕ, or an attenuation amount η₁₂ of the acoustic signal AC1 (first acoustic signal) at the position P2 (second point) with reference to the position P1 (first point) can be set to be larger than or equal to a predetermined value ωₜₕ. Here, the position P1 (first point) is a predetermined point at which the acoustic signal AC1 (first acoustic signal) emitted from the sound hole 121a (first sound hole) reaches. On the other hand, the position P2 (second point) is a predetermined point at which the distance from the acoustic signal output device 10 is longer than the position P1 (first point). The predetermined value ηₜₕ is a value smaller (value lower) than an attenuation rate η₂₁ of any or specific acoustic signal (sound) due to air propagation at the position P2 (second point) with reference to the position P1 (first point). The predetermined value ωₜₕ is a value larger than an attenuation amount η₂₂ due to air propagation of any or specific acoustic signal (sound) at the position P2 (second point) with reference to the position P1 (first point). That is, the acoustic signal output device 10 of the present embodiment is designed such that the attenuation rate η₁₁ is less than or equal to the predetermined value ηₜₕ smaller than the attenuation rate η₂₁, or the attenuation amount η₁₂ is larger than or equal to the predetermined value ωₜₕ larger than the attenuation amount η₂₂. Note that the acoustic signal AC1 is propagated in air from the position P1 to the position P2, and is attenuated due to the air propagation and the acoustic signal AC2. The attenuation rate η₁₁ is a ratio (AMP₂ (AC1)/AMP₁ (AC1)) of a magnitude AMP₂ (AC1) of the acoustic signal AC1 at the position P2 attenuated due to air propagation and the acoustic signal AC2 to a magnitude AMP₁ (AC1) of the acoustic signal AC1 at the position P1. The attenuation amount η₁₂ is a difference (|AMP₁ (AC1)−AMP₂ (AC1)|) between the magnitude AMP₁ (AC1) and the magnitude AMP₂ (AC1). Meanwhile, in a case where the acoustic signal AC2 is not assumed, any or specific acoustic signal ACₐᵣ propagating in air from the position P1 to the position P2 attenuates not due to the acoustic signal AC2 but due to the air propagation. The attenuation rate η₂₁ is a ratio (AMP₂ (ACₐᵣ)/AMP₁ (ACₐᵣ)) of a magnitude AMP₂ (ACₐᵣ) of the acoustic signal ACₐᵣ at the position P2 attenuated due to air propagation (attenuated not due to the acoustic signal AC2) to a magnitude AMP₁ (ACₐᵣ) of the acoustic signal ACₐᵣ at the position P1. The attenuation amount η₂₂ is a difference (|AMP₁ (ACₐᵣ)−AMP₂ (ACₐᵣ)|) between the magnitude AMP₁ (ACₐᵣ) and the magnitude AMP₂ (ACₐᵣ). Note that an example of the magnitude of the acoustic signal is sound pressure of the acoustic signal, energy of the acoustic signal, or the like. Furthermore, the “sound leakage component” means, for example, a component that is highly likely to arrive at a region other than the user wearing the acoustic signal output device 10 (for example, person other than the user wearing the acoustic signal output device 10) of the acoustic signal AC1 emitted from the sound hole 121a. For example, the “sound leakage component” means a component propagating in a direction other than the D1 direction of the acoustic signal AC1. For example, a direct wave of the acoustic signal AC1 is mainly emitted from the sound hole 121a, and a direct wave of the second acoustic signal is mainly emitted from the second sound holes. A part of the direct wave (sound leakage component) of the acoustic signal AC1 emitted from the sound hole 121a is canceled out by interfering with at least a part of the direct wave of the acoustic signal AC2 emitted from the sound holes 123a. However, this does not limit the present invention, and this cancellation may occur in waves other than direct waves. That is, a sound leakage component that is at least one of a direct wave or a reflected wave of the acoustic signal AC1 emitted from the sound hole 121a may be canceled out by at least one of a direct wave or a reflected wave of the acoustic signal AC2 emitted from the sound holes 123a. As a result, sound leakage can be reduced.

An arrangement configuration of the sound holes 121a and 123a will be exemplified.

The sound hole 121a (first sound hole) of the present embodiment is included in a region AR1 (first region) of the wall portion 121 arranged on one side (D1 direction side that is a side to which the acoustic signal AC1 is emitted) of the driver unit 11 (FIG. 1, FIG. 2A, FIG. 2B, and FIG. 3B). That is, the sound hole 121a is opened in the D1 direction (first direction) along the axis A1. The sound holes 123a (second sound holes) of the present embodiment are included in a region AR3 of the wall portion 123 that is in contact with a region AR between the region AR1 (first region) of the wall portion 121 of the housing 12 and a region AR2 (second region) of the wall portion 122 arranged on the D2 direction side (other side that is the side to which the acoustic signal AC2 is emitted) of the driver unit 11. That is, assuming that a direction between the D1 direction (first direction) and the opposite direction of the D1 direction is a D12 direction (second direction) using the center of the housing 12 as a reference (FIG. 3B), the sound hole 121a (first sound hole) is included on the D1 direction side (first direction side) of the housing 12, and the sound holes 123a (second sound holes) are included on the D12 direction side (second direction side) of the housing 12. For example, in a case where the housing 12 includes the first end surface that is the wall portion 121 arranged on one side (D1 direction side) of the driver unit 11, the second end surface that is the wall portion 122 arranged on the other side (D2 direction side) of the driver unit 11, and the side surface that is the wall portion 123 surrounding the space sandwiched between the first end surface and the second end surface around the axis A1 along the emission direction (D1 direction) of the acoustic signal AC1 passing through the first end surface and the second end surface (FIG. 2B, FIG. 3B), the sound hole 121a (first sound hole) is included on the first end surface, and the sound holes 123a (second sound holes) are included on the side surface. In the present embodiment, no sound hole is included on the wall portion 122 side of the housing 12. This is because if a sound hole is included on the wall portion 122 side of the housing 12, the sound pressure level of the acoustic signal AC2 emitted from the housing 12 exceeds a level necessary for canceling out the sound leakage component of the acoustic signal AC1, and the excess is perceived as sound leakage.

As illustrated in FIG. 2A and the like, the sound hole 121a of the present embodiment is arranged on or in the vicinity of the axis A1 along the emission direction (D1 direction) of the acoustic signal AC1. The axis A1 of the present embodiment passes through the center of the region AR1 (first region) of the wall portion 121 arranged on one side (D1 direction side) of the driver unit 11 of the housing 12 or the vicinity of the center. For example, the axis A1 is an axis extending in the D1 direction through the center region of the housing 12. That is, the sound hole 121a of the present embodiment is included at the center position of the region AR1 of the wall portion 121 of the housing 12. In the present embodiment, for simplification of description, an example is described in which a shape of an edge of an open end of the sound hole 121a is a circle (the open end is a circle). The radius of such a sound hole 121a is, for example, 3.5 mm. Note that this does not limit the present invention. For example, the shape of the edge of the open end of the sound hole 121a may be another shape such as an ellipse, a quadrangle, and a triangle. The open end of the sound hole 121a may have a mesh shape. In other words, the open end of the sound hole 121a may be formed by a plurality of holes. In the present embodiment, for simplification of description, an example is described in which one sound hole 121a is included in the region AR1 (first region) of the wall portion 121 of the housing 12. Note that this does not limit the present invention. For example, two or more sound holes 121a may be included in the region AR1 (first region) of the wall portion 121 of the housing 12.

The sound holes 123a (second sound holes) of the present embodiment are desirably arranged in consideration of, for example, the following viewpoints.

(1) Viewpoint of position: The sound holes 123a are arranged such that propagation paths of the acoustic signal AC2 emitted from the sound holes 123a overlap a propagation path of the sound leakage component of the acoustic signal AC1 to be canceled out.

(2) Viewpoint of area: The propagation regions of the acoustic signal AC2 emitted from the sound holes 123a and the frequency characteristics of the housing 12 are different according to the opening areas of the sound holes 123a. The frequency characteristics of the housing 12 affect the frequency characteristics of the acoustic signal AC2 emitted from the sound holes 123a, that is, the amplitude at each frequency. In consideration of such propagation regions and frequency characteristics of the acoustic signal AC2 emitted from the sound holes 123a, the opening areas of the sound holes 123a are determined such that the sound leakage component is canceled out by the acoustic signal AC2 emitted from the sound holes 123a in a region where the sound leakage component is to be canceled out.

From the above viewpoints, for example, the sound holes 123a (second sound holes) are desirably formed as follows.

For example, as illustrated in FIGS. 2B, 3A, and 3C, desirably, a plurality of sound holes 123a (second sound holes) of the present embodiment is included along a circumference (circle) C1 centered on the axis A1 along the emission direction of the acoustic signal AC1 (first acoustic signal). In a case where the plurality of sound holes 123a is included along the circumference C1, the acoustic signal AC2 is emitted radially (radially around the axis A1) from the sound holes 123a to the outside. Here, the sound leakage component of the acoustic signal AC1 is also emitted radially (radially around the axis A1) from the sound hole 121a to the outside. Therefore, by the plurality of sound holes 123a being included along the circumference C1, the sound leakage component of the acoustic signal AC1 can be appropriately canceled out by the acoustic signal AC2. In the present embodiment, for simplification of description, an example is described in which the plurality of sound holes 123a is included on the circumference C1. However, only a plurality of sound holes 123a is required to be included along the circumference C1, and not all the sound holes 123a need to be strictly arranged on the circumference C1.

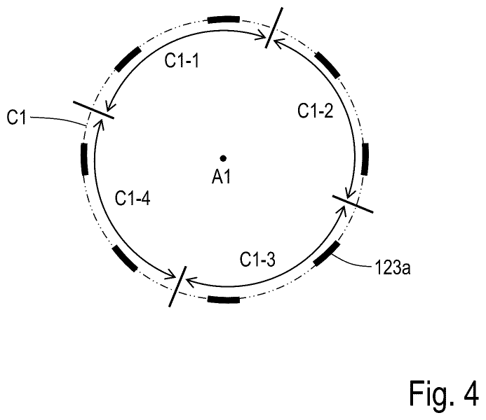

Preferably, in a case where the circumference C1 is equally divided into a plurality of unit arc regions, the sum of the opening areas of sound holes 123a (second sound holes) included along the first arc region that is one of the unit arc regions is the same as or substantially the same as the sum of the opening areas of sound holes 123a (second sound holes) included along the second arc region that is one of the unit arc regions excluding the first arc region. For example, as illustrated in FIG. 4, in a case where the circumference C1 is equally divided into four unit arc regions C1-1, . . . , C1-4, the sum of the opening areas of the sound holes 123a (second sound holes) included on the first arc region (for example, unit arc region C1-1) that is one of the unit arc regions C1-1, . . . , C1-4 is the same as or substantially the same as the sum of the opening areas of the sound holes 123a (second sound holes) included along the second arc region (for example, unit arc region C1-2) that is one of the unit arc regions excluding the first arc region. Here, for simplification of description, an example in which the circumference C1 is equally divided into the four unit arc regions C1-1, . . . , C1-4 has been described, but this does not limit the present invention. “α1 is substantially the same as α2” means that the difference between α1 and α2 is β % or less of α1. Examples of β % include 3%, 5%, and 10%. As a result, a sound pressure distribution of the acoustic signal AC2 emitted from the sound holes 123a included along the first arc region and a sound pressure distribution of the acoustic signal AC2 emitted from the sound holes 123a included along the second arc region are point-symmetric or substantially point-symmetric with respect to the axis A1. Preferably, the sums of the opening areas of sound holes 123a (second sound holes) included along the unit arc regions for the respective unit arc regions are all the same or substantially the same. As a result, the sound pressure distribution of the acoustic signal AC2 emitted from the sound holes 123a is point symmetric or substantially point symmetric with respect to the axis A1. As a result, the sound leakage component of the acoustic signal AC1 can be more appropriately canceled out by the acoustic signal AC2.

More preferably, the plurality of sound holes 123a having the same shape, the same size, and the same interval is desirably included along the circumference C1. For example, the plurality of sound holes 123a having a width of 4 mm and a height of 3.5 mm is included along the circumference C1 in the same shape, the same size, and the same interval. In a case where the plurality of sound holes 123a having the same shape, the same size, and the same interval is included along the circumference C1, the sound leakage component of the acoustic signal AC1 can be more appropriately canceled out by the acoustic signal AC2. However, this does not limit the present invention.

Preferably, the sound holes 123a (second sound holes) are included in the wall portion in contact with the region AR positioned on the other side (D2 direction side) of the driver unit 11 (FIG. 3B). As a result, a direct wave of the acoustic signal AC2 emitted from the other side of the driver unit 11 is efficiently led out from the sound holes 123a to the outside. As a result, the sound leakage component of the acoustic signal AC1 can be more appropriately canceled out by the acoustic signal AC2.

In the present embodiment, for simplicity of description, a case where the shape of the edges of the open ends of the sound holes 123a is a quadrangle (case where the open ends are rectangles) is exemplified, but this does not limit the present invention. For example, the shape of the edges of the open ends of the sound holes 123a may be another shape such as a circle, an ellipse, and a triangle. The open ends of the sound holes 123a may each have a mesh shape. In other words, the open ends of the sound holes 123a may each be formed by a plurality of holes. Further, the number of sound holes 123a is any number, and a single sound hole 123a may be included in the region AR3 of the wall portion 123 of the housing 12, or a plurality of sound holes 123a may be included.

A ratio S₂/S₁ of the sum S₂ of the opening areas of the sound holes 123a (second sound holes) to the sum S₁ of the opening area of the sound hole 121a (first sound hole) desirably satisfies ⅔≤S₂/S₁≤4 (details will be described below). As a result, the sound leakage component of the acoustic signal AC1 can be appropriately canceled out by the acoustic signal AC2.

The sound leakage reduction performance may also depend on the ratio between the area of the wall portion 123 including the sound holes 123a and the opening areas of the sound holes 123a. For example, a case where the housing 12 includes the first end surface that is the wall portion 121 arranged on one side (D1 direction side) of the driver unit 11, the second end surface that is the wall portion 122 arranged on the other side (D2 direction side) of the driver unit 11, and the side surface that is the wall portion 123 surrounding the space sandwiched between the first end surface and the second end surface around the axis A1 along the emission direction (D1 direction) of the acoustic signal AC1 passing through the first end surface and the second end surface, the sound hole 121a (first sound hole) is included on the first end surface, and the sound holes 123a (second sound holes) are included on the side surface is considered (FIG. 2B, FIG. 3B). In such a case, the ratio S₂/S₃ of the sum S₂ of the opening areas of the sound holes 123a to the total area S₃ of the side surface is desirably 1/20≤S₂/S₃≤⅕ (details will be described below). As a result, the sound leakage component of the acoustic signal AC1 can be appropriately canceled out by the acoustic signal AC2. However, this does not limit the present invention.

### <Use State>

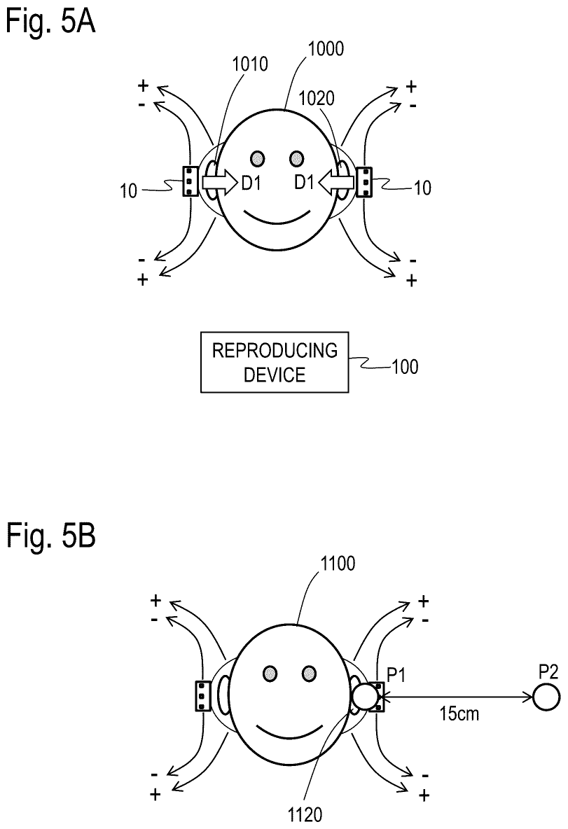

A use state of the acoustic signal output device 10 will be exemplified with reference to FIG. 5A. In the example of FIG. 5A, one acoustic signal output device 10 is worn on each of a right ear 1010 and a left ear 1020 of a user 1000. Any wearing mechanism is used for wearing the acoustic signal output device 10 on the ear. In each acoustic signal output device 10, the D1 direction side is directed to the user 1000 side. An output signal output from a reproducing device 100 is input to the driver unit 11 of each acoustic signal output device 10, and the driver unit 11 emits the acoustic signal AC1 to the D1 direction side and emits the acoustic signal AC2 to the other side. The acoustic signal AC1 is emitted from the sound hole 121a, and the emitted acoustic signal AC1 enters the right ear 1010 or the left ear 1020 and is heard by the user 1000. On the other hand, the acoustic signal AC2 that is an antiphase signal of the acoustic signal AC1 or an approximate signal of the antiphase signal is emitted from the sound holes 123a. A part of the acoustic signal AC2 cancels out a part (sound leakage component) of the acoustic signal AC1 emitted from the sound hole 121a.

### Experiment Result

An experimental result indicating a sound leakage reduction effect by the acoustic signal output device 10 of the present embodiment is described. In this experiment, as illustrated in FIG. 5B, the acoustic signal output devices 10 were worn on both ears of a dummy head 1100 imitating a human head, and an acoustic signal was observed at positions P1 and P2. In this example, the position P1 is a position in the vicinity of the left ear 1120 of the dummy head 1100 (vicinity of the acoustic signal output device 10), and the position P2 is a position 15 cm away outward from the position P1.

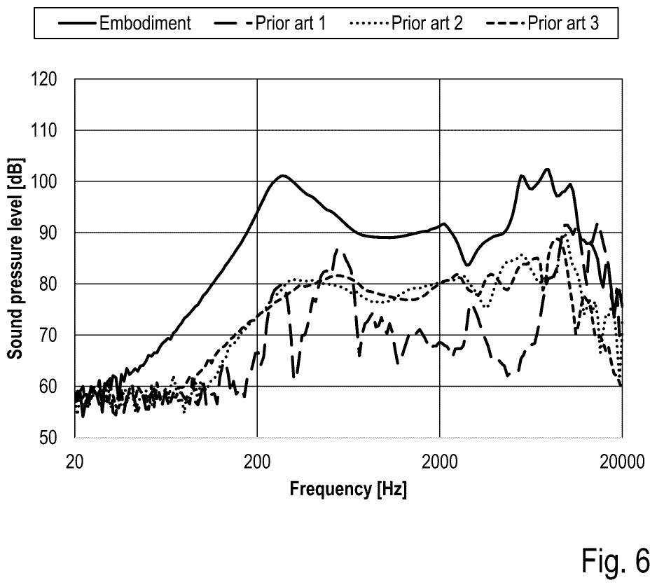

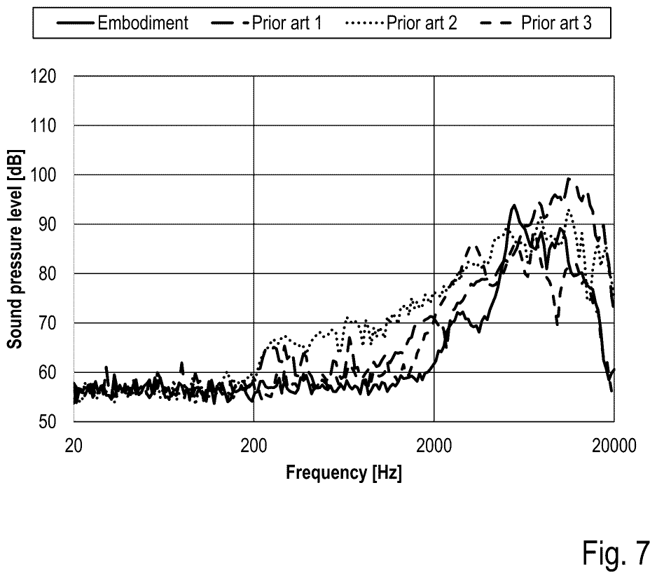

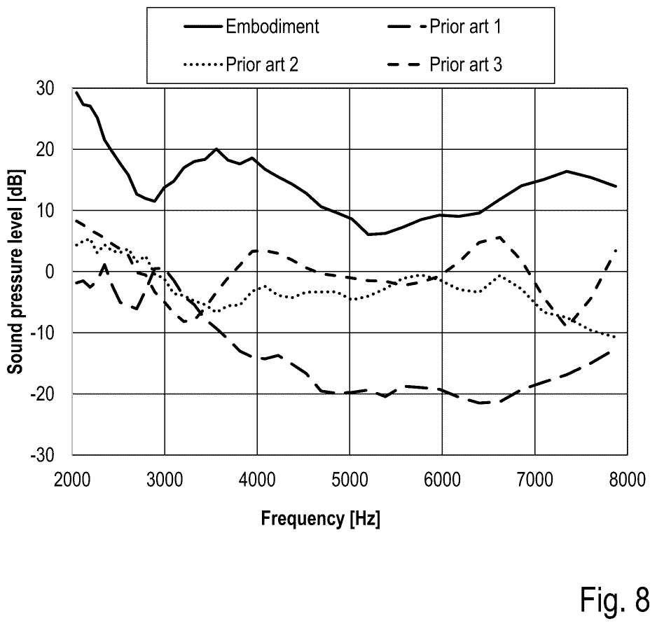

FIG. 6 illustrates frequency characteristics of an acoustic signal observed at the position P1 in FIG. 5B, FIG. 7 illustrates frequency characteristics of an acoustic signal observed at the position P2 in FIG. 5B, and FIG. 8 illustrates a difference between the frequency characteristics of the acoustic signal observed at the position P1 and the frequency characteristics of the acoustic signal observed at the position P2 (difference in sound pressure level of each frequency). The horizontal axis represents a frequency (Frequency [Hz]), and the vertical axis represents a sound pressure level (Sound pressure level (SPL) [dB]). A solid line graph illustrates frequency characteristics in a case where the acoustic signal output devices 10 of the present embodiment are used, and broken line graphs each illustrate frequency characteristics in a case where conventional acoustic signal output devices (open-ear earphones) are used. As illustrated in FIG. 8, it can be seen that a difference between the sound pressure of the acoustic signal observed at the position P1 and the sound pressure of the acoustic signal observed at the position P2 is larger in the case of using the acoustic signal output devices 10 of the present embodiment than in cases of using the conventional acoustic signal output devices. This indicates that the acoustic signal output devices 10 of the present embodiment can reduce sound leakage at the position P2 as compared with the conventional acoustic signal output devices.

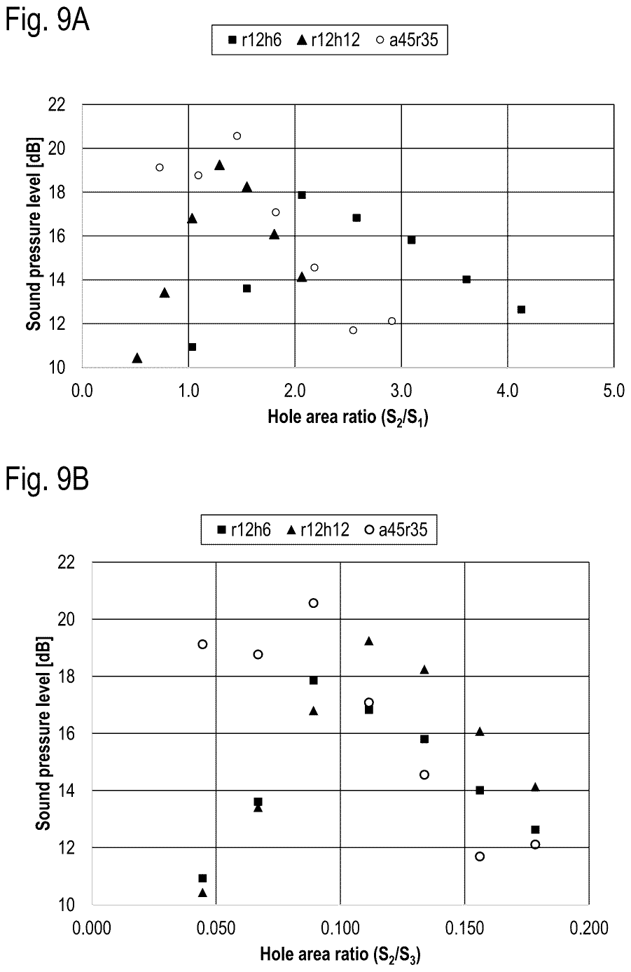

FIG. 9A illustrates a relationship between the ratio S₂/S₁ of the sum S₂ of the opening areas of the sound holes 123a (second sound holes) to the sum S₁ of the opening areas of the sound holes 121a (first sound holes) and the difference between the frequency characteristics of the acoustic signal observed at the position P1 and the frequency characteristic of the acoustic signal observed at the position P2. The horizontal axis represents the ratio S₂/S₁, and the vertical axis represents a sound pressure level (Sound pressure level (SPL) [dB]) representing the difference. r12h6 exemplifies a result in a case where the number of the sound holes 121a is six and the number of the sound holes 123a is four, r12h12 exemplifies a result in a case where the number of the sound holes 121a is twelve and the number of sound holes 123a is four, and r45h35 exemplifies a result in a case where the number of the sound holes 121a is one and the number of the sound holes 123a is four. As illustrated in FIG. 9A, it can be seen that, particularly in the range in which the ratio S₂/S₁ of the sum S₂ of the opening areas of the sound holes 123a to the sum S₁ of the opening areas of the sound holes 121a is ⅔≤S₂/S₁<4, the difference between the sound pressure of the acoustic signal observed at the position P1 and the acoustic signal observed at the position P2 is large. This indicates that the sound leakage reduction effect in this range is large.

FIG. 9B illustrates a relationship between the ratio S₂/S₃ of the sum S₂ of the opening areas of the sound holes 123a (second sound holes) to the total area S₃ of the side surface and the difference between the frequency characteristics of the acoustic signal observed at the position P1 and the frequency characteristic of the acoustic signal observed at the position P2. The horizontal axis represents the ratio S₂/S₃, and the vertical axis represents a sound pressure level (Sound pressure level (SPL) [dB]) representing the difference. The meanings of r12h6, r12h12, and r45h35 are the same as those in FIG. 9A. As illustrated in FIG. 9B, it can be seen that, particularly in the range in which the ratio S₂/S₃ of the sum S₂ of the opening areas of the sound holes 123a (second sound holes) to the total area S₃ of the side surface is 1/20≤S₂/S₃≤⅕, the difference between the sound pressure of the acoustic signal observed at the position P1 and the acoustic signal observed at the position P2 is large. This indicates that the sound leakage reduction effect in this range is large.

### [Modification 1 of First Embodiment]

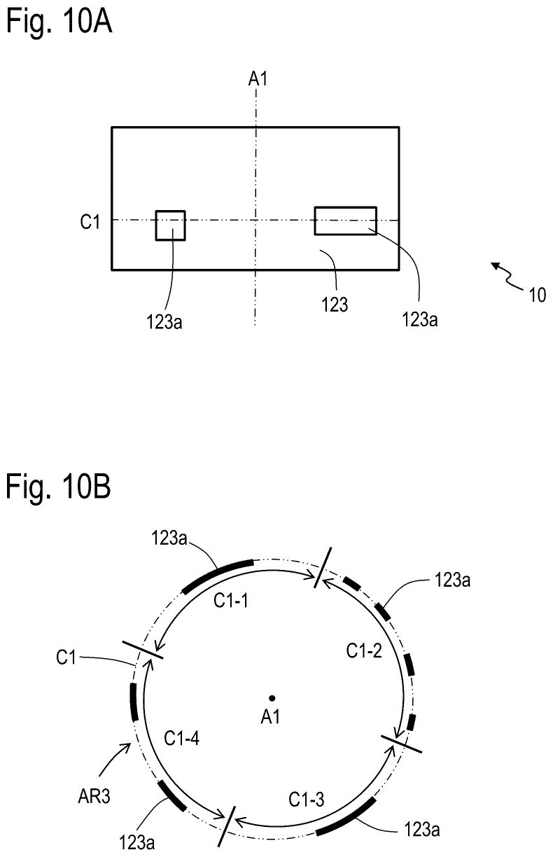

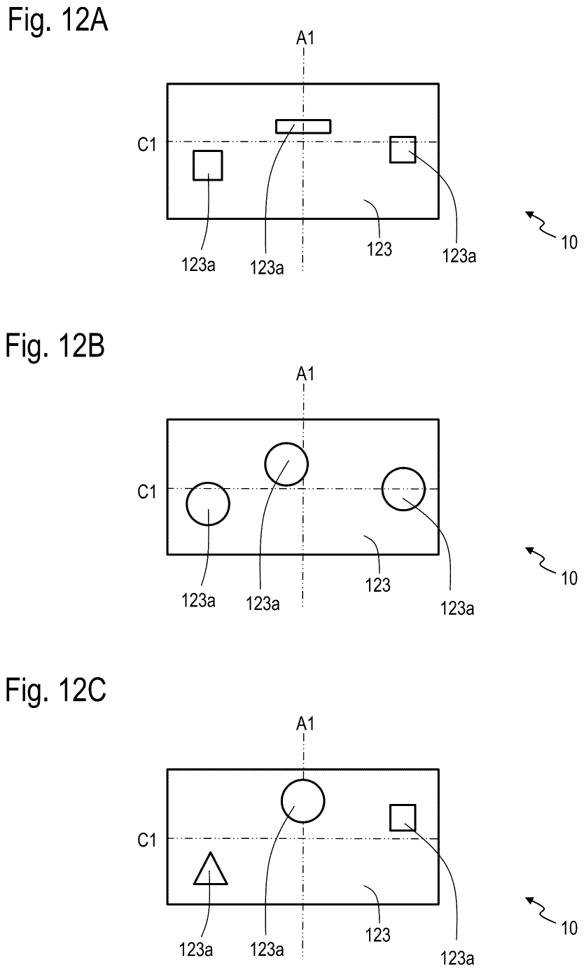

In the first embodiment, an example has been described in which a plurality of sound holes 123a (second sound holes) having the same shape, the same size, and the same interval is included along the circumference C1. Note that this does not limit the present invention. A plurality of sound holes 123a having different shapes and/or sizes and/or intervals may be included along the circumference C1. For example, as illustrated in FIGS. 10A, 10B, 11A, 11B, and 12A, a plurality of sound holes 123a having different shapes and intervals may be included in the wall portion 123 along the circumference C1, as illustrated in FIG. 12B, a plurality of sound holes 123a having different intervals may be included in the wall portion 123 along the circumference C1, or as illustrated in FIG. 12C, a plurality of sound holes 123a having different shapes and sizes may be included in the wall portion 123 along the circumference C1.

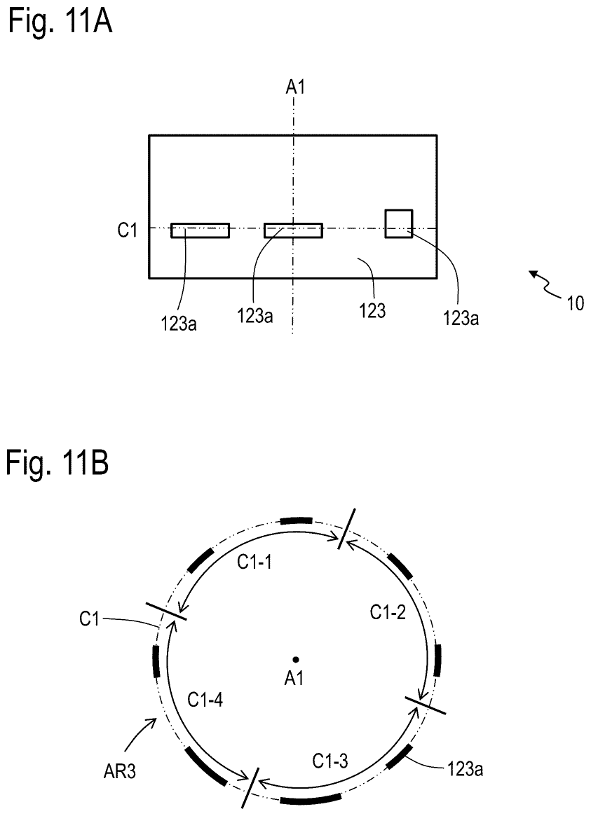

Even in such a case, in a case where the circumference C1 is equally divided into a plurality of unit arc regions, the sum of the opening areas of sound holes 123a (second sound holes) included along the first arc region that is one of the unit arc regions is preferably the same as or substantially the same as the sum of the opening areas of sound holes 123a included along the second arc region that is one of the unit arc regions excluding the first arc region. More preferably, the sums of the opening areas of sound holes 123a included along the unit arc regions for the respective unit arc regions are preferably all the same or substantially the same. For example, as illustrated in FIGS. 10A, 10B, 11A, and 11B, although the number and size of the sound holes 123a included in the unit arc regions C1-1, C1-2, C1-3, and C1-4 are different from each other, the sum of the opening areas of sound holes 123a included in the unit arc region C1-1, the sum of the opening areas of sound holes 123a included in the unit arc region C1-2, the sum of the opening areas of sound holes 123a included in the unit arc region C1-3, and the sum of the opening areas of sound holes 123a included in the unit arc region C1-4 are desirably all the same or substantially the same.

Only a plurality of sound holes 123a is required to be along the circumference C1, and not all the sound holes 123a need to be strictly arranged on the circumference C1. For example, as illustrated in FIGS. 12A, 12B, and 12C, not all the sound holes 123a need to be arranged on the circumference C1, and only the plurality of sound holes 123a is required to be arranged along the circumference C1. Note that the position of the circumference C1 is not limited to that exemplified in the first embodiment, and is only required to be a circumference centered on the axis A1.

As long as a sufficient sound leakage reduction effect can be obtained, not all the sound holes 123a need to be arranged along the circumference C1. That is, some sound holes 123a may be arranged at positions deviated from the circumference C1. The number of sound holes 123a is any number as long as a sufficient sound leakage reduction effect can be obtained, and one sound hole 123a may be included.

### [Modification 2 of First Embodiment]

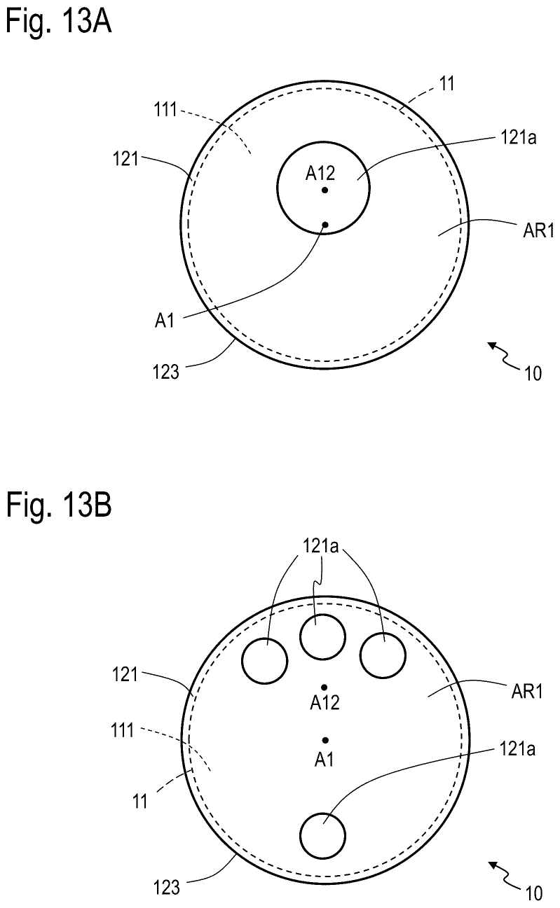

In the first embodiment, the configuration has been exemplified in which one sound hole 121a is arranged at the center position of the region AR1 of the wall portion 121 of the housing 12 (region of the wall portion arranged on one side of the driver unit) (hereinafter, the position is simply referred to as a “center position”). However, a plurality of sound holes 121a may be included in the region AR1 of the wall portion 121 of the housing 12, or a sound hole 121a may be biased to an eccentric position deviated from the center (center position) of the region AR1 of the wall portion 121 of the housing 12. For example, as illustrated in FIG. 13A, one sound hole 121a may be included at an eccentric position on the region AR1 (position on an axis A12 parallel to the axis A1 deviated from the axis A1) (hereinafter, the position is simply referred to as an “eccentric position”). In other words, the position of one sound hole 121a included in the region AR1 may be biased to the eccentric position. Alternatively, as illustrated in FIG. 13B, a plurality of sound holes 121a may be included in the region AR1, and the plurality of sound holes 121a may be biased to eccentric positions on the axis A12 parallel to the axis A1 deviated from the axis A1. In other words, the positions of a plurality of sound holes 121a included in the region AR1 may be biased to the eccentric positions. That is, a single sound hole 121a may be included, or a plurality of sound holes may be included, and a sound hole 121a may be biased to the center position of the region AR1 of the wall portion 121 of the housing 12, or may be biased to an eccentric position. Note that the distance between the axis A1 and the axis A2 is any distance, and is only required to be set according to required sound leakage reduction performance. An example of the distance between the axis A1 and the axis A2 is 4 mm, but this does not limit the present invention.

The resonance frequency of the housing 12 can be controlled by an arrangement configuration of the sound holes 121a (for example, number, size, interval, arrangement, and the like of the sound holes 121a) included in the region AR1. The resonance frequency of the housing 12 affects frequency characteristics of acoustic signals emitted from the sound holes 121a and 123a. Therefore, the frequency characteristics of the acoustic signals emitted from the sound holes 121a and 123a can be controlled by the arrangement configuration of the sound holes 121a included in the region AR1. For example, in a case where the frequencies of the acoustic signals AC1 and AC2 become high, the wavelengths become short, and performing phase matching such that the sound leakage component of the acoustic signal AC1 emitted to the outside is canceled out by the acoustic signal AC2 becomes difficult. As a result, the higher the frequencies of the acoustic signals AC1 and AC2, the more difficult reduction of sound leakage of the acoustic signal AC1. Since the sound pressure levels of the acoustic signals AC1 and AC2 increase at the resonance frequency of the housing 12, if the resonance frequency of the housing 12 belongs to a high frequency band in which reduction of sound leakage is difficult, sound leakage is perceived large. In order to solve this issue, the arrangement configuration of the sound holes 121a may be set as in following Examples 2-1, 2 so that the resonance frequency of the housing 12 is controlled.

### Example 2-1

In a high frequency band in which reduction of sound leakage is difficult, the arrangement configuration of the sound holes 121a may be set such that human auditory sensitivity for the resonance frequency of the housing 12 is low. For example, it is assumed that Sa is human auditory sensitivity (audibility) for an acoustic signal having a resonance frequency equal to or higher than a predetermined frequency fₜₕ of the housing 12 in which the position of the sound hole 121a is biased to a certain eccentric position. Furthermore, it is assumed that S_{c} is human auditory sensitivity for an acoustic signal having a resonance frequency equal to or higher than the predetermined frequency fₜₕ of the housing 12 in which the sound hole 121a is included in the center position. It is assumed that the auditory sensitivity S_{d} in this case is lower than the auditory sensitivity S_{c}. That is, the human auditory sensitivity S_{d} for an acoustic signal having a resonance frequency equal to or higher than the predetermined frequency fₜₕ of the housing 12 in which the position of the sound hole 121a (first sound hole) is biased to a certain eccentric position (position deviated from the center of the region of the wall portion arranged on one side of the driver unit) is lower than the human auditory sensitivity S_{c} for an acoustic signal having a resonance frequency equal to or higher than the predetermined frequency fₜₕ of the housing 12 in a case where it is assumed that the sound hole 121a is included at the center position (center of the region of the wall portion arranged on one side of the driver unit). The position of the sound hole 121a may be biased to such an eccentric position. Note that the auditory sensitivity may be of any type as long as it is an index indicating audibility of sound. The higher the auditory sensitivity, the higher the audibility. An example of the auditory sensitivity is the reciprocal of the sound pressure level of sound required for a human to perceive sound of reference loudness. For example, the reciprocal of the sound pressure level at each frequency in the equal loudness curve is the auditory sensitivity. The predetermined frequency fₜₕ means a lower limit of a frequency band including a frequency in which canceling out of the sound leakage component of the acoustic signal AC1 by the acoustic signal AC2 is difficult. Examples of the predetermined frequency fₜₕ include 3000 Hz, 4000 Hz, 5000 Hz, and 6000 Hz.

### Example 2-2

Depending on the arrangement configuration of the sound holes 121a, the resonance peak of the magnitude of the acoustic signal AC1 and/or the acoustic signal AC2 emitted from the housing 12 may be distorted. For example, it is assumed that Q_{d} is peak sharpness (fineness of point) at a frequency equal to or higher than the predetermined frequency fₜₕ of the magnitude of the acoustic signal AC1 emitted from the sound hole 121a of the housing 12 in which the position of the sound hole 121a is biased to a certain eccentric position and/or the acoustic signal AC2 emitted from the sound holes 123a. Furthermore, it is assumed that Q_{c} is peak sharpness at a frequency equal to or higher than the predetermined frequency fₜₕ of the magnitude of the acoustic signal AC1 emitted from the sound hole 121a of the housing 12 in which the sound hole 121a is included at the center position and/or the acoustic signal AC2 emitted from the sound holes 123a. The peak sharpness Q_{d} in this case is assumed to be blunter than the peak sharpness Qc. That is, the peak sharpness Q_{d} at a frequency equal to or higher than the predetermined frequency fₜₕ of the magnitude of the acoustic signal AC1 (first acoustic signal) emitted from the sound hole 121a (first sound hole) of the housing 12 in which the position of the sound hole 121a (first sound hole) is biased to a certain eccentric position and/or the acoustic signal AC2 (second acoustic signal) emitted from the sound holes 123a (second sound holes) is blunter than the peak sharpness Q_{c} at a frequency equal to or higher than the predetermined frequency fₜₕ of the magnitude of the acoustic signal AC1 (first acoustic signal) emitted from the sound hole 121a (first sound hole) of the housing 12 in a case where it is assumed that the sound hole 121a is included at the center position and/or the acoustic signal AC2 (second acoustic signal) emitted from the sound holes 123a (second sound holes). In other words, the peak at a frequency equal to or higher than the predetermined frequency fₜₕ of the magnitude of the acoustic signal AC1 and/or the acoustic signal AC2 emitted from the housing 12 in which the position of the sound hole 121a is biased to a certain eccentric position is flattened more than the peak at a frequency equal to or higher than the predetermined frequency fₜₕ of the magnitude of the acoustic signal AC1 and/or the acoustic signal AC2 emitted from the housing 12 in a case where it is assumed that the sound hole 121a is included at the center position. The position of the sound hole 121a may be biased to such an eccentric position.

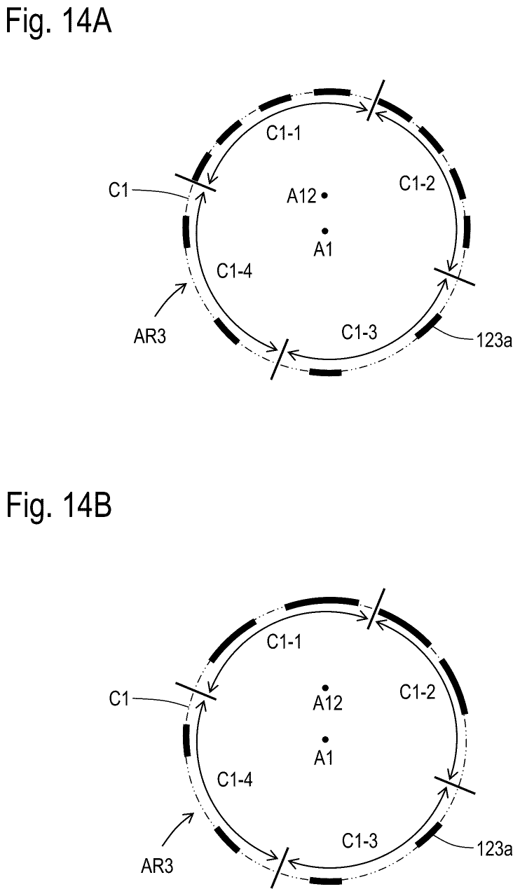

In a case where the position of a single or plurality of sound holes 121a is biased to an eccentric position, the distribution or opening areas of the sound holes 123a may be biased accordingly. For example, as illustrated in FIG. 13A or FIG. 13B, the position of a single or plurality of sound holes 121a included in the region AR1 may be biased to an eccentric position on the axis A12 deviated from the axis A1, and as illustrated in FIGS. 14A and 14B, the opening areas of the sound holes 121a included in the region AR3 may also be biased to the eccentric position side on the axis A12. In the example of FIG. 14A, the number of sound holes 123a included along the unit arc region C1-3 farther from the eccentric position on the axis A12 is smaller than the number of sound holes 123a included along the unit arc region C1-1 closer to the eccentric position. In the example of FIG. 14B, each opening area of the sound holes 123a included along the unit arc region C1-3 farther from the eccentric position on the axis A12 in the example of FIG. 14A is smaller than each opening area of the sound holes 123a included along the unit arc region C1-1 closer to the eccentric position. That is, in a case where the circumference C1 is equally divided into a plurality of unit arc regions, the sum of the opening areas of sound holes 123a (second sound holes) included along the first arc region (for example, C1-3) that is one of the unit arc regions is smaller than the sum of the opening areas of sound holes 123a included along the second arc region (for example, C1-1) that is one of the unit arc regions closer to the eccentric position than the first arc region. In a case where the position of the sound hole 121a is biased to an eccentric position, the distribution of the acoustic signal AC1 emitted from the sound hole 121a to the outside is also biased to the eccentric position. Here, the distribution and the opening areas of the sound holes 123a are also made biased to the eccentric position, so that the distribution of the acoustic signal AC2 emitted from the sound holes 123a to the outside can also be biased to the eccentric position. As a result, the sound leakage component of the acoustic signal AC1 can be more sufficiently canceled out by the emitted acoustic signal AC2.

In order to control the resonance frequency of the housing 12 for other purposes, the sound hole 121a may be biased to an eccentric position deviated from the center (center position) of the region AR1 of the wall portion 121 of the housing 12. The size of the opening portions of the sound holes 121a, 123, the thickness of the wall portion of the housing 12, and the volume inside the housing 12 affect the resonance frequency of the housing 12. Therefore, by at least a part of these being controlled, the resonance frequency of the housing 12 can be higher or lower. That is, the larger the size of the opening portions of the sound holes 121a, 123, the thinner the thickness of the wall portion of the housing 12, and the smaller the volume inside the housing 12, the higher the resonance frequency of the housing 12. Conversely, the smaller the size of the opening portions of the sound holes 121a, 123, the thicker the thickness of the wall portion of the housing 12, and the larger the volume inside the housing 12, the lower the resonance frequency of the housing 12.

### [Modification 3 of First Embodiment]

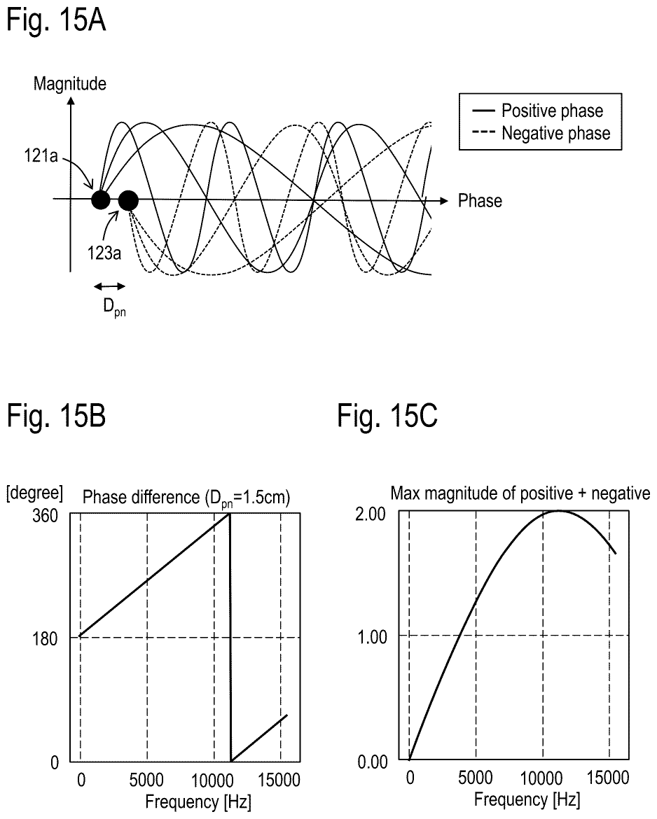

FIG. 15A illustrates a state in which the acoustic signal AC1 that is a sine wave is emitted from the sound hole 121a (first sound hole) and the acoustic signal AC2 (second acoustic signal) that is an antiphase signal (phase inversion signal) of the acoustic signal AC1 is emitted from the sound holes 123a (second sound holes). Here, the horizontal axis in FIG. 15A represents the phase (Phase [degree]), and the vertical axis represents the magnitude (for example, amplitude or power) of the acoustic signals AC1 and AC2. The sound hole 121a and the sound holes 123a are separated from each other by a distance Dₚₙ. An example of Dₚₙ is 1.5 cm. As described above, a part of the acoustic signal AC1 emitted from the sound hole 121a is canceled out by a part of the acoustic signal AC2 emitted from the sound holes 123a, thereby reducing sound leakage of the acoustic signal AC1. However, the acoustic signals AC1 and AC2 have a phase difference based on the distance Dₚₙ. FIG. 15B illustrates a relationship between the phase difference and the frequency in a case where the distance Dₚₙ is 1.5 cm. Here, the horizontal axis in FIG. 15B represents a frequency (Frequency [Hz]), and the vertical axis represents a phase difference (Phase difference [degree]). As illustrated in FIG. 15B, the higher the frequency, the farther the phase difference is from 180°. Due to the influence of this phase difference, the acoustic signal AC1 emitted from the sound hole 121a and the acoustic signal AC2 emitted from the sound holes 123a do not have completely opposite phases. In particular, since the phases of components of a wavelength λ that satisfies Dₚₙ=(λ/2)+nλ among the acoustic signals AC1 and AC2 match each other, sound leakage is rather emphasized. Here, n is a positive integer. That is, an acoustic signal component having a wavelength closer to λ that satisfies Dₚₙ=(λ/2)+nλ is less likely to reduce sound leakage. FIG. 15C illustrates a relationship between the maximum value of a sum of the magnitude of the acoustic signal AC1 and the acoustic signal AC2 observed at a position 15 cm outside the acoustic signal output device and the frequencies of the acoustic signals AC1 and AC2 in a case where the distance Dₚₙ is 1.5 cm. In FIG. 15C, the horizontal axis represents the frequency (Frequency [Hz]), and the vertical axis represents the ratio of the maximum value of the sum of the magnitude of the acoustic signal AC1 and the acoustic signal AC2 with respect to the acoustic signal AC1. In the example of FIG. 15C, due to the above-described influence, it can be seen that the ratio of the maximum value of the sum of the magnitude of the acoustic signal AC1 and the acoustic signal AC2 with respect to the acoustic signal AC1 exceeds 1 from around 3000 Hz, and sound leakage cannot be sufficiently reduced. Although the waveform in FIG. 15C can be changed by the distance Dₚₙ being adjusted, the adjustable distance Dₚₙ has a limitation due to mechanical constraints of the arrangement, shape, and the like of the sound holes 121a and 123a, and sound leakage cannot necessarily be sufficiently reduced in a desired frequency band.

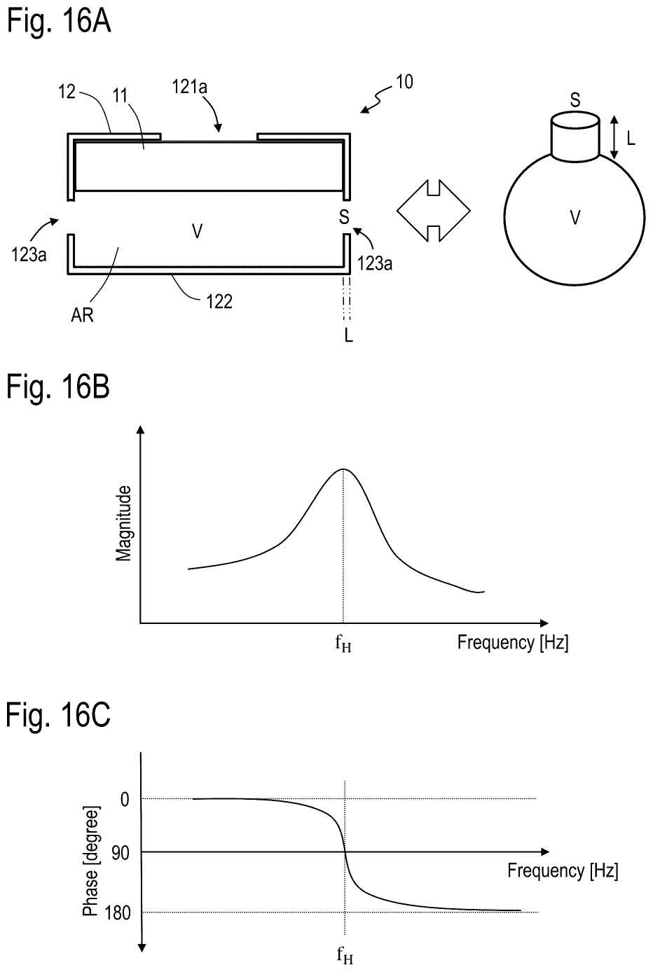

Therefore, the issue is solved by the resonance frequency based on the Helmholtz resonance being controlled. As illustrated in FIG. 16A, the acoustic signal output device 10 can be modeled as a Helmholtz resonator (enclosure) in which the length in the depth direction of the sound hole 121a (first sound hole) and the sound holes 123a (second sound holes) (duct length, for example, depth of the sound holes 121a and 123a) is L [mm], the sum of the opening areas of the sound hole 121a (first sound hole) and the sound holes 123a (second sound holes) is S [mm²], and the volume (capacity) of the internal space (for example, region AR) of the housing 12 is V [mm³]. The resonance frequency f_{H} [Hz] based on the Helmholtz resonance of the housing 12 modeled in this manner is as follows.

$$\begin{matrix}[ Math . 1 ] & \\ {f}_{H} = \frac{c}{2 π} \sqrt{\frac{S}{V ( L + F ( S ) )}} & ( 1 )\end{matrix}$$

Here, c is the sound speed, S=S₁+ . . . +S_{K} is satisfied, Sₖ (k=1, . . . , K) is the opening area of each of the sound holes 121a and 123a, and K is the total number of the sound holes 121a and 123a. F is a function, and F(S) is a function value by the function F of S. The function F depends on the shape of the sound holes 121a and 123a. For example, when the sound holes 121a and 123a are rectangular, F(S)=S^{1/2}. FIG. 16B illustrates a relationship between the resonance frequency f_{H} and the magnitude of the acoustic signal AC2 (negative-phase signal) in the housing 12. Here, the horizontal axis in FIG. 16B represents the frequency (Frequency [Hz]), and the vertical axis represents the magnitude of the acoustic signal AC2 emitted from the driver unit 11 to the internal space (region AR) of the housing 12. As illustrated in FIG. 16B, the magnitude of the acoustic signal AC2 emitted from the driver unit 11 to the internal space of the housing 12 is maximum at the resonance frequency f_{H}. The phase of the acoustic signal AC2 emitted from the driver unit 11 to the internal space of the housing 12 greatly changes around the resonance frequency f_{H}. FIG. 16C illustrates a relationship between the phase and the frequency of the acoustic signal AC2 emitted from the driver unit 11 to the internal space of the housing 12. Here, the horizontal axis in FIG. 16C represents the frequency (Frequency [Hz]), and the vertical axis represents the phase (Phase [degree]) of the acoustic signal AC2 emitted to the outside from the sound holes 123a with respect to the phase of the acoustic signal AC2 emitted from the driver unit 11 to the internal space of the housing 12 (acoustic signal AC2 at the time of being emitted from the driver unit 11 to the internal space of the housing 12 is used as a reference). As illustrated in FIG. 16C, the phase of the acoustic signal AC2 emitted from the driver unit 11 to the internal space of the housing 12 is delayed by 90° at the resonance frequency f_{H}, and approaches the phase delayed by 180° as the frequency increases. By the resonance frequency f_{H} [Hz] based on the Helmholtz resonance of the housing 12 being controlled, the phase of the acoustic signal AC2 emitted from the sound holes 123a to the outside is adjusted, and sound leakage at a desired frequency is reduced.

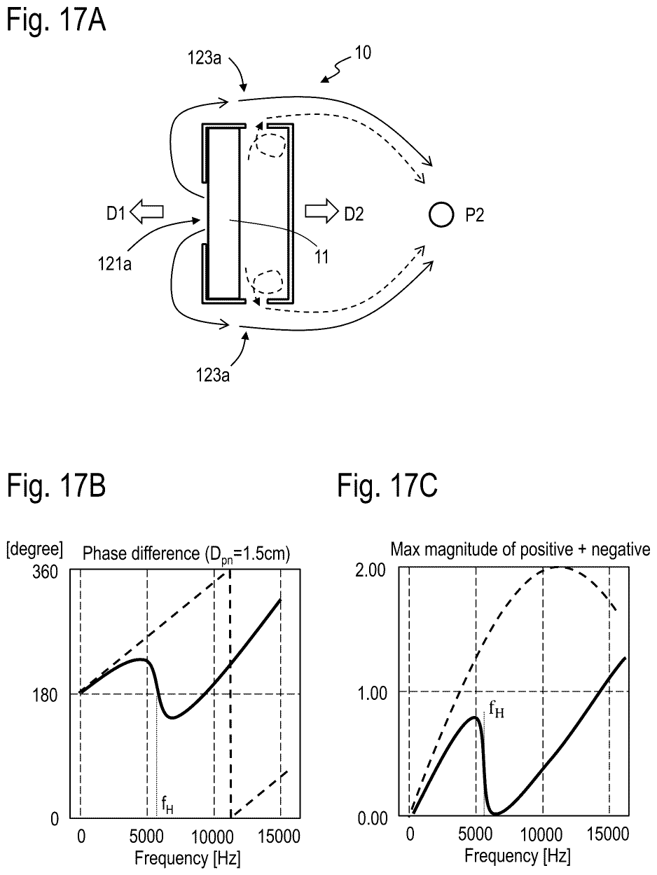

That is, as illustrated in FIG. 17A, the acoustic signal AC1 emitted to one side (D1 direction side) of the driver unit 11 is emitted from the sound hole 121a to the outside of the acoustic signal output device 10, and a part thereof reaches the position P2 on the other side (D2 direction side) of the acoustic signal output device 10. The acoustic signal AC2 emitted to the other side (D2 direction side) of the driver unit 11 is delayed in phase as described above on the basis of the Helmholtz resonance of the housing 12 and emitted from the sound holes 123a to the outside of the acoustic signal output device 10, and a part thereof reaches the position P2. Here, it is possible to adjust the phase of the acoustic signal AC2 emitted from the driver unit 11 to the internal space of the housing 12 by adjusting lengths L in the depth direction of the sound holes 121a and 123a, a sum S of the opening areas of the sound holes 121a and 123a, and a volume V of the internal space of the housing 12 and appropriately adjusting the resonance frequency f_{H} based on the Helmholtz resonance of the housing 12 on the basis of Formula (1) described above. As a result, the phase difference between the acoustic signal AC1 and the acoustic signal AC2 at the position P2 can be brought close to 180° at a desired frequency, and sound leakage can be sufficiently reduced. FIG. 17B illustrates a relationship between the phase difference between the acoustic signal AC1 and the acoustic signal AC2 at the position P2 and the frequency in a case where the resonance frequency f_{H} [Hz] based on the Helmholtz resonance of the housing 12 in which the distance Dₚₙ is 1.5 cm is adjusted. Here, the horizontal axis in FIG. 17B represents a frequency (Frequency [Hz]), and the vertical axis represents a phase difference (Phase difference [degree]). FIG. 17C illustrates a relationship between the maximum value of a sum of the magnitude of the acoustic signal AC1 and the acoustic signal AC2 observed at the position P2 and the frequencies of the acoustic signals AC1 and AC2. In FIG. 17C, the horizontal axis represents the frequency (Frequency [Hz]), and the vertical axis represents the ratio of the maximum value of the sum of the magnitude of the acoustic signal AC1 and the acoustic signal AC2 with respect to the acoustic signal AC1. As illustrated in FIG. 17B, it can be seen that, by the length L, the sum S of the opening areas, and the volume V being adjusted such that the resonance frequency f_{H} is about 6000 Hz, as illustrated in FIG. 17C, the maximum value of the sum of the magnitude of the acoustic signal AC1 and the acoustic signal AC2 with respect to the acoustic signal AC1 can be made less than 1 in a wide frequency band, and sound leakage can be sufficiently reduced. Since sound leakage should be reduced for a frequency within the audible frequency band, the length L, the sum of the opening areas S, and the volume V (length L in depth direction of the sound hole 121a and the sound holes 123a, sum S of the opening areas of the sound hole 121a and the sound holes 123a, and volume V of the internal space of the housing 12) are designed such that at least the resonance frequency f_{H} belongs to a predetermined frequency band within the audible frequency band.

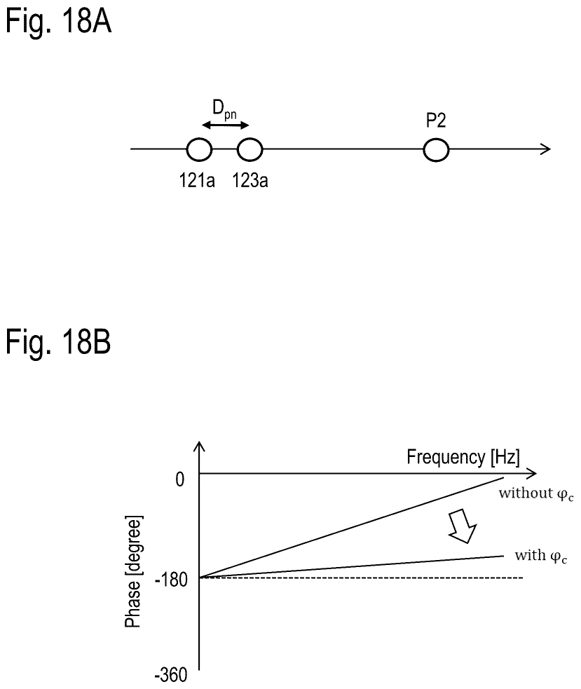

More specific description will be given. As illustrated in FIG. 18A, an environment is assumed in which the sound hole 121a and the sound holes 123a are separated from each other by the distance Dₚₙ and sound leakage at the position P2 is reduced. y is the magnitude of an observation signal at the position P2, ω is the frequency of the acoustic signals AC1 and AC2, t is time, A is a positive constant representing the maximum value of the magnitude of an acoustic signal, φᵢₙᵢₜ is a constant representing an initial phase of the acoustic signals AC1 and AC2, and a phase difference between the acoustic signals AC1 and AC2 based on the distance Dₚₙ is φ_{Dpn}. In a case where it is assumed that there is no factor for delaying the acoustic signal AC2 with respect to the acoustic signal AC1 other than the distance Dₚₙ, the following relationship is satisfied.

$$y = Asin ( ω t - {ϕ}_{init} + {ϕ}_{Dpn} ) + Asin ( ω t - Π - {ϕ}_{init} ) \qquad ( 2 )$$

$${ϕ}_{Dpn} = - ( {D}_{pn} ω ) / c \qquad ( 3 )$$

Due to the phase difference φ_{Dpn}, the acoustic signal AC2 does not have a phase opposite to that of the acoustic signal AC1, and sound leakage at the position P2 may not be sufficiently reduced depending on the phase difference φ_{Dpn}. Therefore, a phase difference (phase delay) (c for canceling out the phase difference φ_{Dpn} is introduced into the acoustic signal AC2 emitted to the outside of the acoustic signal output device 10. In a case where such a phase difference φ_{c} is introduced, the following relationship is satisfied.

$$y = Asin ( ω t - {ϕ}_{init} + {ϕ}_{Dpn} ) + Asin ( ω t - Π - {ϕ}_{init} + {ϕ}_{c} ) \qquad ( 4 )$$

By the phase difference φ_{c} close to the phase difference φ_{Dpn} being introduced, the magnitude of y in Formula (4) can be reduced, and sound leakage at the position P2 can be reduced. In the present modification, by the resonance frequency f_{H} based on the Helmholtz resonance of the housing 12 being adjusted by optimization of the length L, the sum S of the opening areas, and the volume V, the phase difference φ_{c} close to the phase difference φ_{Dpn} is introduced into the acoustic signal AC2 emitted to the outside of the acoustic signal output device 10. By such a phase difference φ_{c} being introduced (with φ_{c}), the phase difference between the acoustic signal AC1 and the acoustic signal AC2 at the position P2 in the frequency band where the sound leakage is to be reduced can be brought close to 180° as compared with a case without the phase difference φ_{c} (without φ_{c}) (FIG. 18B). As a result, sound leakage can be sufficiently reduced in this frequency band.

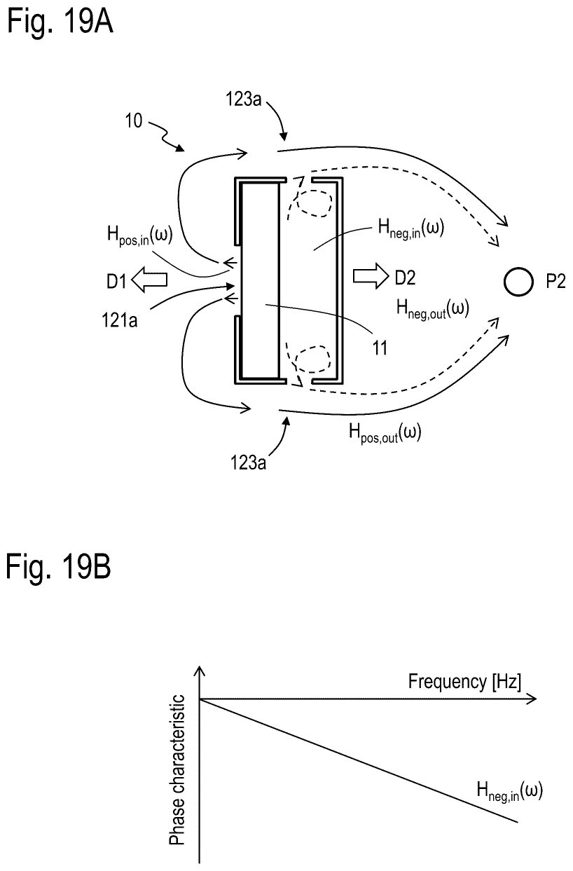

This will be described using a transfer function model. As illustrated in FIG. 19A, an environment is assumed in which the sound hole 121a and the sound holes 123a are separated from each other by the distance Dₚₙ and sound leakage at the position P2 is reduced. A frequency region signal of the observation signal at the position P2 is Yₗᵢₛ (ω), a transfer function in the internal region from one side (D1 direction side) of the driver unit 11 to the sound hole 121a is H_{pos,in} (ω), a transfer function in an external region from the sound hole 121a to the position P2 is H_{pos,out} (ω), a transfer function in the internal region from the other side (D2 direction side) of the driver unit 11 to the sound holes 123a is H_{neg,in} (ω), and a transfer function in the external region from the sound holes 123a to the position P2 is H_{neg,out} (ω). A frequency region signal of the acoustic signal AC1 emitted from one side (D1 direction side) of the driver unit 11 is Sₚₒₛ (ω), and a frequency region signal of the acoustic signal AC2 emitted from the other side (D2 direction side) of the driver unit 11 is S_{neg} (ω). In this case, the following relationship is satisfied.

$${Y}_{lis} ( ω ) = {H}_{pos , out} ( ω ) {H}_{pos , in} ( ω ) {S}_{pos} ( ω ) + {H}_{neg , out} ( ω ) {H}_{neg , in} ( ω ) {S}_{neg} ( ω ) \qquad ( 5 )$$

Here, a frequency region signal of an acoustic signal emitted from a sound source inside the driver unit 11 is Sₛₒᵤ (ω), a transfer function of one side (D1 direction side) of the sound source inside the driver unit 11 is H_{pos,spk} (ω), and a transfer function of the other side (D2 direction side) of the sound source inside the driver unit 11 is H_{neg,spk} (ω). Then, the following is satisfied.

$${S}_{pos} ( ω ) = {H}_{pos , spk} ( ω ) {S}_{sou} ( ω ) \qquad ( 6 )$$

$${S}_{neg} ( ω ) = - {H}_{neg , spk} ( ω ) {S}_{sou} ( ω ) \qquad ( 7 )$$

From above Formulas (5), (6), and (7), in order to satisfy |Yₗᵢₛ (ω)|=0, the length L, the sum S of the opening areas, and the volume V are only required to be designed such that the transfer function H_{neg,in} (ω) of the region from the other side (D2 direction side) of the driver unit 11 to the sound holes 123a satisfies the following.

$${H}_{neg , in} ( ω ) = {H}_{pos , out} ( ω ) {H}_{pos , in} ( ω ) {H}_{pos , spk} ( ω ) / {H}_{neg , out} ( ω ) {H}_{neg , spk} ( ω ) \qquad ( 8 )$$

Here, assuming that H_{pos,spk} (ω)=H_{neg,spk} (ω) is satisfied at the frequency ω at which sound leakage is to be reduced, and H_{pos,in} (ω) can be approximated to 1, Formula (8) can be modified as follows.

$${H}_{neg , in} ( ω ) = {H}_{pos , out} ( ω ) / {H}_{neg , out} ( ω ) \qquad ( 9 )$$

Here, assuming that it is a free sound field and the reverberation of the housing 12 can be ignored, it can be regarded that the phase characteristic of the transfer functions H_{pos,out} (ω), H_{neg,out} (ω) is linear. That is, it can be regarded that the transfer functions H_{pos,out} (ω), H_{neg,out} (ω) depend only on delay based on the distance. In this case, as illustrated in FIG. 19B, it can be regarded that the phase characteristic of H_{neg,in} (ω) of Formula (9) is also linear with respect to the frequency ω. Therefore, ideally, by the length L, the sum S of the opening areas, and the volume V being appropriately designed such that the phase characteristic H_{neg,in} (ω) satisfies Formula (9) or approaches the right side of Formula (9) in a frequency band where sound leakage at the position P2 is to be reduced, sound leakage can be sufficiently reduced in this frequency band. For example, by the length L, the sum S of the opening areas, and the volume V being designed such that any one of the following condition examples 1 to 7 being satisfied, sound leakage can be sufficiently reduced in this frequency band.

### Condition Example 1

For any frequency ω, H_{neg,in} (ω) matches or approximates to H_{pos,out} (ω)/H_{neg,out} (ω) (Formula (9)). Provided that the frequency ω belongs to a predetermined frequency band of the audible frequency band. The predetermined frequency band is, for example, a frequency band where sound leakage at the position P2 is to be reduced.

### Condition Example 2

$$\vert {Y}_{lis} ( ω ) \vert < \vert {H}_{pos , out} ( ω ) {H}_{pos , in} ( ω ) {S}_{pos} ( ω ) \vert \qquad ( 10 a )$$

$$and$$

$$\vert {Y}_{lis} ( ω ) \vert < \vert {H}_{neg , out} ( ω ) {H}_{neg , in} ( ω ) {S}_{neg} ( ω ) \vert \qquad ( 10 b )$$

### Condition Example 3

$$\vert {Y}_{lis} ( ω ) \vert < \vert {H}_{pos , out} ( ω ) {H}_{pos , in} ( ω ) {S}_{pos} ( ω ) \vert \qquad ( 10 a )$$

$$or$$

$$\vert {Y}_{lis} ( ω ) \vert < \vert {H}_{neg , out} ( ω ) {H}_{neg , in} ( ω ) {S}_{neg} ( ω ) \vert \qquad ( 10 b )$$

### Condition Example 4

$$\vert {Y}_{lis} ( ω ) \vert < \vert {H}_{pos , out} ( ω ) {S}_{pos} ( ω ) \vert \qquad ( 11 a )$$

$$and$$

$$\vert {Y}_{lis} ( ω ) \vert < \vert {H}_{neg , out} ( ω ) {H}_{neg , in} ( ω ) {S}_{neg} ( ω ) \vert \qquad ( 10 b )$$

### Condition Example 5

$$\vert {Y}_{lis} ( ω ) \vert < \vert {H}_{pos , out} ( ω ) {S}_{pos} ( ω ) \vert \qquad ( 11 a )$$

$$or$$

$$\vert {Y}_{lis} ( ω ) \vert < \vert {H}_{neg , out} ( ω ) {H}_{neg , in} ( ω ) {S}_{neg} ( ω ) \vert \qquad ( 10 b )$$

### Condition Example 6

The following design condition 1 and/or design condition 2 is satisfied.

### Design Condition 1:

The sound pressure level of the acoustic signal AC1 (first acoustic signal) at the position P2 (second point) in a case where the acoustic signal AC1 (first acoustic signal) is emitted from the sound hole 121a (first sound hole) and the acoustic signal AC2 (second acoustic signal) is emitted from the sound holes 123a (second sound holes) is smaller than the sound pressure level of the acoustic signal AC1 (first acoustic signal) at the position P2 (second point) in a case where the acoustic signal AC1 (first acoustic signal) is emitted from the sound hole 121a (first sound hole) but the acoustic signal AC2 (second acoustic signal) is not emitted from the sound holes 123a (second sound holes) (for example, Formulas (10a) (11a)).

### Design Condition 2:

The sound pressure level of the acoustic signal AC1 (first acoustic signal) at the position P2 (second point) in a case where the acoustic signal AC1 (first acoustic signal) is emitted from the sound hole 121a (first sound hole) and the acoustic signal AC2 (second acoustic signal) is emitted from the sound holes 123a (second sound holes) is smaller than the sound pressure level of the acoustic signal AC1 (first acoustic signal) at the position P2 (second point) in a case where the acoustic signal AC1 (first acoustic signal) is not emitted from the sound hole 121a (first sound hole) but the acoustic signal AC2 (second acoustic signal) is emitted from the sound holes 123a (second sound holes) (for example, Formula (10b)).

### Condition Example 7

The resonance frequency based on the Helmholtz resonance of the housing 12 belongs to a frequency band of 3000 Hz or more and 8000 Hz or less.

### Experiment Result

An experimental result indicating a sound leakage reduction effect by the acoustic signal output device 10 of the present modification is described. In this experiment, as illustrated in FIG. 5B, the acoustic signal output devices 10 were worn on both ears of a dummy head 1100 imitating a human head, and an acoustic signal was observed at positions P1 and P2. In this example, the position P1 is a position in the vicinity of the left ear 1120 of the dummy head 1100 (vicinity of the acoustic signal output device 10), and the position P2 is a position 15 cm away outward from the position P1.

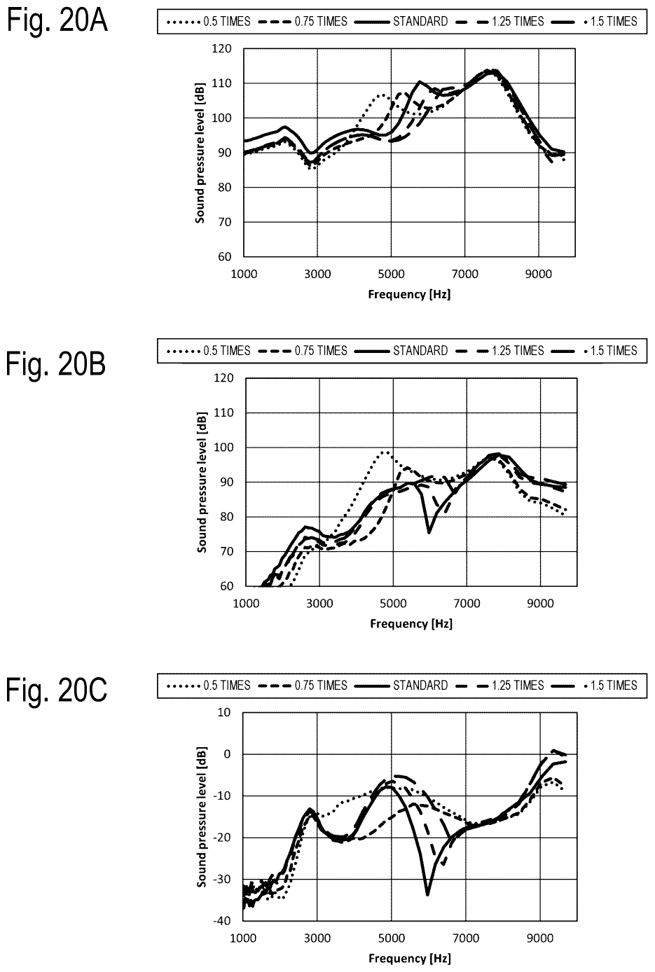

First, frequency characteristics due to a difference in the sum S of the opening areas of the sound hole 121a and the sound holes 123a will be exemplified. FIG. 20A illustrates frequency characteristics of an acoustic signal observed at the position P1 in FIG. 5B, FIG. 20B illustrates frequency characteristics of an acoustic signal observed at the position P2 in FIG. 5B, and FIG. 20C illustrates a difference between the frequency characteristics of the acoustic signal observed at the position P1 and the frequency characteristics of the acoustic signal observed at the position P2 (difference in sound pressure level of each frequency). The horizontal axis represents a frequency (Frequency [Hz]), and the vertical axis represents a sound pressure level (Sound pressure level (SPL) [dB]). Here, the opening area of the sound hole 121a was fixed, and acoustic signal output devices 10 having five types of opening areas of the sound holes 123a were evaluated. Each of the acoustic signal output devices 10 includes one sound hole 121a and four sound holes 123a. Note that “standard” indicates an acoustic signal output device 10 in which the sum of the opening areas of the four sound holes 123a is 56 mm², and “0.5 times”, “0.75 times”, “1.25 times”, and “1.5 times” indicate acoustic signal output devices 10 in which the sum of the opening areas of the four sound holes 123a is 0.5 times, 0.75 times, 1.25 times, and 1.5 times 56 mm², respectively. The resonance frequencies f_{H} [Hz] of the housing 12 of the acoustic signal output devices 10 of “0.5 times”, “0.75 times”, “standard”, “1.25 times”, and “1.5 times” obtained according to Formula (1), assuming that F(S)=S^{1/2}, are as follows.

TABLE 1

| | Resonance |
|---|---|
| Condition | frequency f_{H} [Hz] |

| | | |
|---|---|---|
| 0.5 | times | 4260 |
| 0.75 | times | 4829 |

| | |
|---|---|
| Standard | 5266 |

| | | |
|---|---|---|
| 1.25 | times | 5626 |
| 1.5 | times | 5934 |

As illustrated in FIGS. 20A and 20B, the frequency characteristics of the acoustic signal observed at the position P1 and the acoustic signal observed at the position P2 are different depending on the difference in the sum S of the opening areas. As a result, as illustrated in FIG. 20C, the frequency characteristics of the difference of the sound pressure of the acoustic signal observed at the position P1 and the acoustic signal observed at the position P2 are also different depending on the difference in the sum S of the opening areas, and the sound leakage reduction performance at the position P2 is also different. For example, in acoustic signal output devices 10 of “standard”, “1.25 times”, and “1.5 times”, sound leakage is minimized at frequencies slightly higher than the respective resonance frequencies f_{H}, and this corresponds to the relationship illustrated in FIG. 17C.

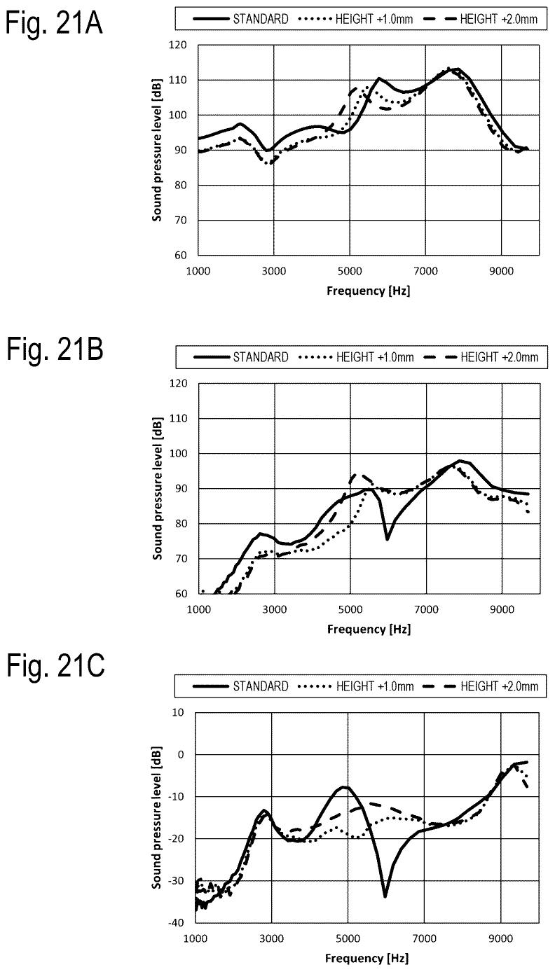

Next, frequency characteristics due to a difference in volume V of the region AR (internal space) of the housing 12 will be exemplified. FIG. 21A illustrates frequency characteristics of an acoustic signal observed at the position P1 in FIG. 5B, FIG. 21B illustrates frequency characteristics of an acoustic signal observed at the position P2 in FIG. 5B, and FIG. 21C illustrates a difference between the frequency characteristics of the acoustic signal observed at the position P1 and the frequency characteristics of the acoustic signal observed at the position P2 (difference in sound pressure level of each frequency). The horizontal axis represents a frequency (Frequency [Hz]), and the vertical axis represents a sound pressure level (Sound pressure level (SPL) [dB]). Here, three types of acoustic signal output devices 10 having different volumes V due to different heights of additional members arranged in the entire region AR2 of the housing 12 were evaluated. Note that “standard” represents an acoustic signal output device 10 in which the height of the additional member is a reference value, and “height+1.0 mm” and “height+2.0 mm” represent acoustic signal output devices 10 in which the heights of the additional members are higher by 1.0 mm and 2.0 mm than the “standard”, respectively. Assuming that F(S)=S^{1/2}, the resonance frequencies f_{H} [Hz] of the housing 12 of the acoustic signal output devices 10 of “standard”, “height+1.0 mm”, and “height+2.0 mm” obtained according to Formula (1) are as follows.

TABLE 2

| | Resonance |
|---|---|
| Condition | frequency f_{H} [Hz] |
| Standard | 5266 |
| Height +1.0 mm | 4563 |
| Height +2.0 mm | 4083 |

As illustrated in FIGS. 21A and 21B, the frequency characteristics of the acoustic signal observed at the position P1 and the acoustic signal observed at the position P2 are different depending on the difference in the volume V of the internal space of the housing 12. As a result, as illustrated in FIG. 21C, the frequency characteristics of the difference of the sound pressure of the acoustic signal observed at the position P1 and the acoustic signal observed at the position P2 are also different depending on the difference in the volume V of the internal space of the housing 12, and the sound leakage reduction performance at the position P2 is also different. For example, in acoustic signal output devices 10 of “standard” and “height+1.0 mm”, sound leakage is minimized at frequencies slightly higher than the respective resonance frequencies f_{H}, and this corresponds to the relationship illustrated in FIG. 17C.

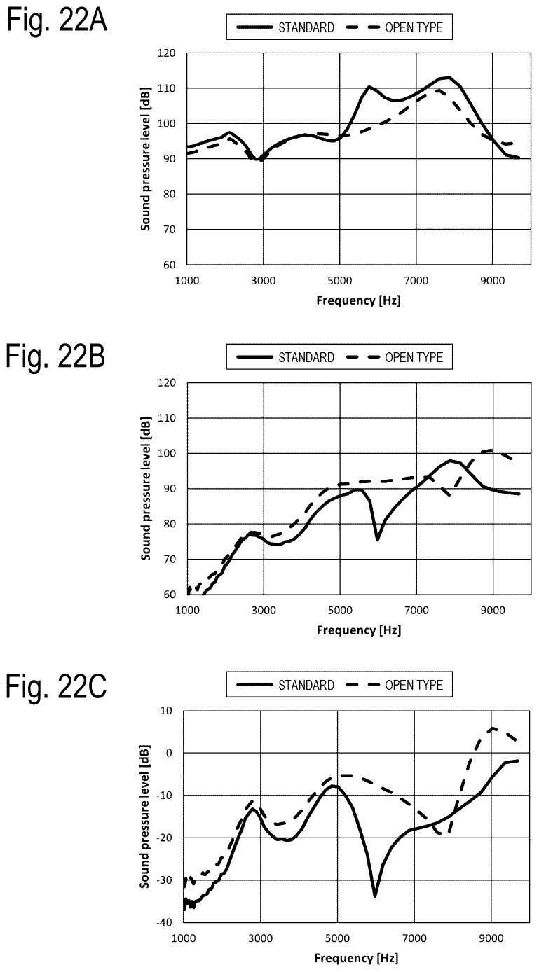

Next, frequency characteristics of the acoustic signal output device 10 of the embodiment (reference: with an enclosure that is the region AR surrounded by the wall portions 122, 123) and the open acoustic signal output device (without an enclosure) will be exemplified. Note that, in the open acoustic signal output device, the wall portion 122 on the D1 direction side of the driver unit 11 of the acoustic signal output device 10 does not exist, and the region AR is opened to the D2 direction side. FIG. 22A illustrates frequency characteristics of an acoustic signal observed at the position P1 in FIG. 5B, FIG. 22B illustrates frequency characteristics of an acoustic signal observed at the position P2 in FIG. 5B, and FIG. 22C illustrates a difference between the frequency characteristics of the acoustic signal observed at the position P1 and the frequency characteristics of the acoustic signal observed at the position P2 (difference in sound pressure level of each frequency). The horizontal axis represents a frequency (Frequency [Hz]), and the vertical axis represents a sound pressure level (Sound pressure level (SPL) [dB]). As illustrated in FIGS. 22A and 22B, the frequency characteristics of the acoustic signal observed at the position P1 and the acoustic signal observed at the position P2 are different depending on the presence or absence of the enclosure. As a result, as illustrated in FIG. 22C, it can be seen that the acoustic signal output device 10 of the embodiment including the enclosure can reduce sound leakage at the position P2 in a wider frequency band than the acoustic signal output device not including the enclosure.

As described above, it can be seen that, by the resonance frequency f_{H} based on the Helmholtz resonance of the housing 12 being appropriately adjusted, the phase of the acoustic signal AC2 emitted from the driver unit 11 to the internal space of the housing 12 can be adjusted, and thereby sound leakage in a desired frequency band can be sufficiently reduced.

### Second Embodiment

A second embodiment is a modification of the modification 3 of the first embodiment. As described in the modification 3 of the first embodiment, a resonance frequency f_{H} [Hz] based on Helmholtz resonance of a housing 12 is determined as in Formula (1) on the basis of a sum S of opening areas of sound holes of the housing 12, a volume V of an internal space of the housing 12, and a length L of the sound holes in a depth direction. In the present embodiment, at least one of S, V, or L is mechanically changed, thereby changing the resonance frequency f_{H} based on the Helmholtz resonance of the housing. That is, an acoustic signal output device of the present embodiment includes a housing 12 (structure unit) provided with a single or a plurality of sound holes 121a (first sound holes) that emits an acoustic signal AC1 (first acoustic signal) to an outside, a hollow portion having an internal space into which an acoustic signal AC2 (second acoustic signal) is emitted, and a single or a plurality of sound holes 123a (second sound holes) that emits the acoustic signal AC2 (second acoustic signal) emitted to the internal space of the hollow portion to the outside, and a single or a plurality of mechanism units that changes at least one of an opening area of the sound hole 121a (first sound hole) or the sound hole 123a (second sound hole), a length from the internal space of the hollow portion to an opening end of the sound hole 121a (first sound hole) or the sound hole 123a (second sound hole), or a volume of the internal space of the hollow portion. As described above, when the acoustic signal AC1 (first acoustic signal) is emitted from the sound hole 121a (first sound hole) and the acoustic signal AC2 (second acoustic signal) is emitted from the sound hole 123a (second sound hole), an attenuation rate η₁₁ of the acoustic signal AC1 (first acoustic signal) at a position P2 (second point) with reference to a position P1 (first point) can be set to be equal to or less than a predetermined value ηₜₕ, or an attenuation amount η₁₂ of the acoustic signal AC1 (first acoustic signal) at the position P2 (second point) with reference to the position P1 (first point) can be set to be equal to or larger than a predetermined value ωₜₕ. Here, it is possible to change the resonance frequency f_{H} based on the Helmholtz resonance of the housing 12 by changing at least one of the opening area of the sound hole 121a (first sound hole) or the sound hole 123a (second sound hole), the length from the internal space of the hollow portion to the opening end of the sound hole 121a (first sound hole) or the sound hole 123a (second sound hole), or the volume of the internal space of the hollow portion by the mechanism unit. As a result, it is possible to adjust a phase of the acoustic signal AC2 emitted from the sound hole 123a to the outside and to suppress sound leakage at a desired frequency.

### Configuration Example 1

A configuration example 1 of the present embodiment is illustrated in FIGS. 1, 2A to 2C, and 23A to 23C.

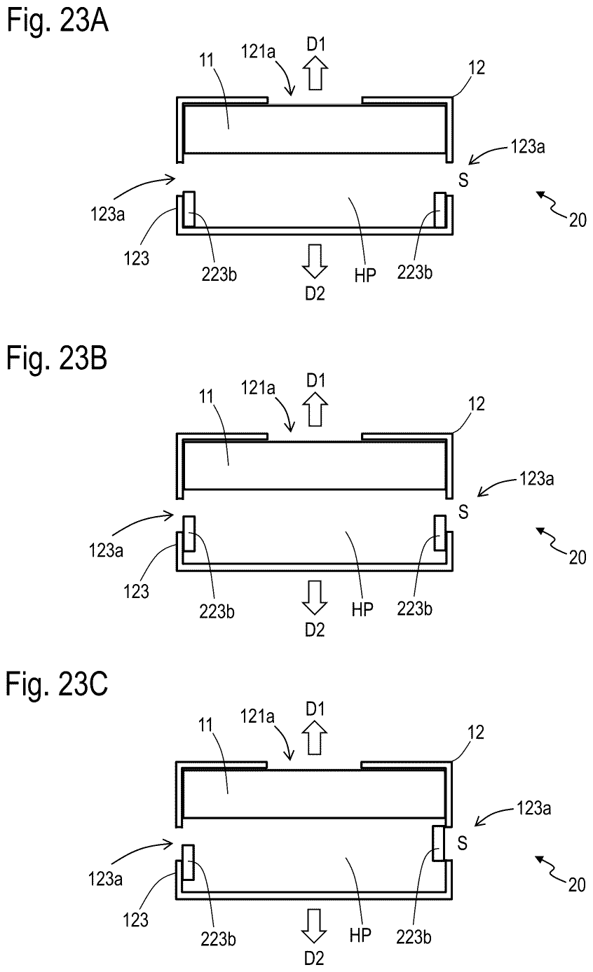

As illustrated in FIGS. 23A to 23C, an acoustic signal output device 20 of the configuration example 1 of the present embodiment includes a driver unit 11, the housing 12 (structure unit) accommodating the driver unit 11, and provided with the single or the plurality of sound holes 121a (first sound holes) that emits the acoustic signal AC1 (first acoustic signal) emitted from a D1 direction side of the driver unit 11 to the outside, a hollow portion HP having the internal space into which the acoustic signal AC2 (second acoustic signal) emitted from a D2 direction side of the driver unit 11 is emitted, and the single or the plurality of sound holes 123a (second sound holes) that emits the acoustic signal AC2 (second acoustic signal) emitted to the internal space of the hollow portion HP to the outside, and a single or a plurality of mechanism units 223b that changes an opening area of the sound hole 123a (second sound hole). As illustrated in FIGS. 23A to 23C, the mechanism unit 223b of this example is a shutter that changes the opening area of the sound hole 123a by opening and closing. In a case where a plurality of the sound holes 123a is present, the opening areas may be controlled to be equal to or substantially equal to each other (for example, FIGS. 23A and 23B), or the opening areas may be controlled to be different from each other (for example, FIG. 23C). As a result, the sum S of the opening areas of the sound hole 121a and the sound hole 123a can be changed, whereby the resonance frequency f_{H} based on the Helmholtz resonance of the hollow portion HP can be changed. Further, the sound hole 123a (second sound hole) may be able to be opened and closed by the mechanism unit 223b, and a sound pressure at a specific position of the acoustic signal AC1 (first acoustic signal) emitted from the sound hole 121a (first sound hole) when the sound hole 123a (second sound hole) is closed may be designed to be higher than a sound pressure at the specific position of the acoustic signal AC1 (first acoustic signal) emitted from the sound hole 121a (first sound hole) when the sound hole 123a (second sound hole) is opened. As a result, it is possible to increase the sound pressure of the acoustic signal AC1 (first acoustic signal) emitted from the sound hole 121a (first sound hole) by closing the sound hole 123a (second sound hole) by the mechanism unit 223b in outdoors where sound leakage does not cause a problem. Note that, here, the mechanism unit 223b changes only the opening area of the sound hole 123a. However, the mechanism unit 223b may change the opening areas of the sound hole 121a and the sound hole 123a. Alternatively, the mechanism unit 223b may change only the opening area of the sound hole 121a.

### Configuration Example 2

A configuration example 2 of the present embodiment is illustrated in FIGS. 1, 2A to 2C, and 24A to 24C.

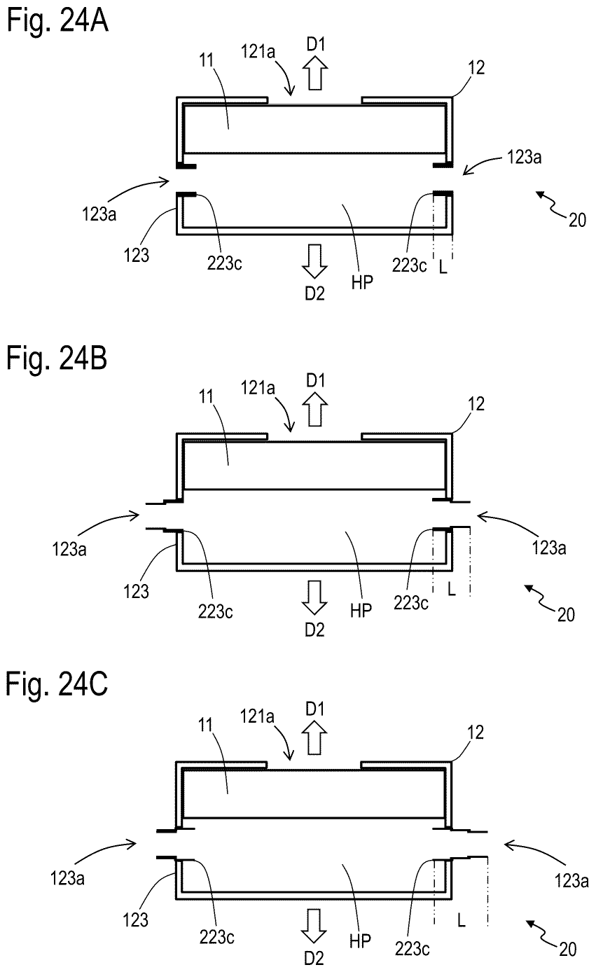

As illustrated in FIGS. 24A to 24C, the acoustic signal output device 20 of the configuration example 2 of the present embodiment includes a single or a plurality of mechanism units 223c instead of the mechanism units 223b of the configuration example 1. The mechanism unit 223c mechanically changes the length L from the internal space of the hollow portion HP to the opening end of the sound hole 123a (second sound hole). As a result, the resonance frequency f_{H} based on the Helmholtz resonance of the hollow portion HP can be changed. The mechanism unit 223c in this example is a tube capable of changing the length L from the internal space of the hollow portion HP to the opening end of the sound hole 123a (second sound hole). In a case where there is a plurality of the sound holes 123a, the lengths L from the internal space of the hollow portion HP to the opening ends of the respective sound holes 123a may be controlled to be equal to or substantially equal to each other (for example, FIGS. 24A and 24B), or the lengths L may be controlled to be different from each other (for example, FIG. 24C). Note that, here, the mechanism unit 223c changes the length from the internal space of the hollow portion HP to the opening end of the sound hole 123a (second sound hole), but the mechanism unit 223c may further change the length from the internal space of the hollow portion HP to the opening end of the sound hole 121a (first sound hole). Alternatively, the mechanism unit 223c may change only the length from the internal space of the hollow portion HP to the opening end of the sound hole 121a (first sound hole).

### Configuration Example 3

A configuration example 3 of the present embodiment is illustrated in FIGS. 1, 2A to 2C, and 25A to 25C.

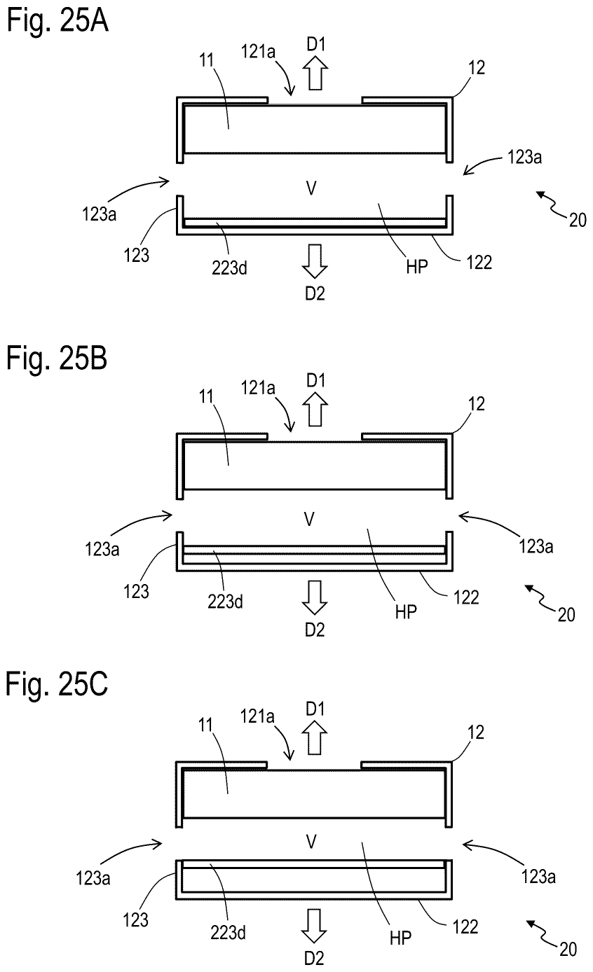

As illustrated in FIGS. 25A to 25C, the acoustic signal output device 20 of the configuration example 3 of the present embodiment includes a mechanism unit 223d instead of the mechanism units 223b of the configuration example 1. The mechanism unit 223d mechanically changes the volume V of the internal space of the hollow portion HP. The mechanism unit 223d in this example is a plate-like member provided inside a wall portion 122 on a D2 direction side of the housing 12, and can change the volume V of the internal space of the hollow portion HP by the mechanism unit 223d moving in a D1-D2 direction. As a result, the resonance frequency f_{H} based on the Helmholtz resonance of the hollow portion HP can be changed.

### Configuration Example 4

A configuration obtained by combining any of the configuration examples 1 to 3 of the present embodiment may be adopted. That is, the acoustic signal output device 20 may include any two or more types of the mechanism units 223b, 223c, and 223d. Furthermore, movement and deformation of the mechanism unit 223b, 223c, or 223d in the configuration examples 1 to 3 or the configuration obtained by combining any of the configuration examples 1 to 3 may be based on electromagnetic power or may be based on manual operation by a user. That is, it is sufficient that the configuration is capable of operating at least one of the mechanism units 223b, 223c, or 223d to change the resonance frequency f_{H} by electromagnetic power or manual operation. That is, any configuration may be adopted as long as the configuration is capable of mechanically changing at least one of S, V, or L expressed by Formula (1). Furthermore, in the configurations of the configuration examples 1 to 3 or the configuration obtained by combining any of the configuration examples 1 to 3, a configuration in which at least any of the mechanism units 223b, 223c, or 223d is adaptively controlled according to an environment such as noise around the acoustic signal output device 20 or location information, and the resonance frequency f_{H} is changed to one suitable for the environment may be adopted. That is, at least one of S, V, or L may be adaptively controlled according to the environment of the acoustic signal output device 20 to change the resonance frequency f_{H} suitable for the environment.

### Configuration Example 5

A sound pressure level of the acoustic signal AC2 emitted from the sound hole 123a to the outside is maximized at the resonance frequency f_{H} of the hollow portion HP. Therefore, to suppress sound leakage on a high-frequency side, it is desirable to control the mechanism units 223b, 223c, and 223d to set the resonance frequency f_{H} to be equal to or higher than a band in which human auditory sensitivity is high (for example, 6 kHz or higher).

However, when the resonance frequency f_{H} is set to be equal to or higher than the band in which human auditory sensitivity is high, the sound pressure level also increases in a band around the resonance frequency f_{H}, and the sound pressure level also increases in the band in which human auditory sensitivity is high. Therefore, when the resonance frequency f_{H} of the hollow portion HP becomes equal to or higher than the above-described predetermined frequency (for example, the band in which human auditory sensitivity is high, for example, 6 kHz) by controlling the mechanism units 223b, 223c, and 223d, the high-frequency side of the acoustic signal AC2 emitted from the sound hole 123a to the outside may be reduced. As a result, the sound leakage in the band in which human auditory sensitivity is high (for example, a band of 3 to 6 kHz) can be reduced. That is, when the resonance frequency f_{H} of the hollow portion HP becomes equal to or higher than the above-described predetermined frequency, the driver unit 11 may emit the acoustic signal AC2 (second acoustic signal) in which a frequency band component (for example, a band component having high human auditory sensitivity, for example, a band component of 3 to 6 kHz) including the above-described predetermined frequency is suppressed into the internal space of the hollow portion HP. For example, as illustrated in FIG. 1, a low-pass filter (LPF) unit 200 may be provided between a reproducing device 100 that outputs an output signal for driving the driver unit 11 and the driver unit 11. The low-pass filter suppresses (attenuates or flattens) the frequency band component including the above-described predetermined frequency when the resonance frequency f_{H} of the hollow portion HP becomes equal to or higher than the predetermined frequency. For example, a cutoff frequency of the low-pass filter is set to 3 kHz. Note that, when the resonance frequency f_{H} falls below the above-described predetermined frequency, the high-frequency side of the acoustic signal AC2 emitted from the sound hole 123a to the outside is not suppressed (not reduced). The output signal output from the reproducing device 100 is input to the LPF unit 200, and the LPF unit 200 outputs a low-pass output signal obtained by attenuating the high-frequency side of the output signal. The low-pass output signal is input to the driver unit 11, and the driver unit 11 is driven on the basis of the low-pass output signal. As a result, the driver unit 11 emits the acoustic signal AC2 (second acoustic signal) in which the frequency band component including the above-described predetermined frequency is suppressed to the internal space of the hollow portion HP. The acoustic signal AC2 (second acoustic signal) emitted into the internal space of the hollow portion HP is further emitted from the sound hole 123a to the outside. Note that the LPF unit 200 may be implemented by an electronic component such as a coil or a capacitor, or may be implemented by digital processing. In a case where the LPF unit 200 is constituted by electronic components such as a resistor and a capacitor, a power supply for driving the LPF unit 200 becomes unnecessary. In this case, a wired acoustic signal output device 20 that does not require a power supply can be used. Note that the LPF unit 200 may be provided outside the housing 12 or may be provided in the housing 12 itself.

Further, as illustrated in FIG. 1, a switching unit 210 may be further provided, which switches between the driver unit 11 emitting the acoustic signal AC2 (second acoustic signal) in which the frequency band component including the above-described predetermined frequency is suppressed into the internal space of the hollow portion HP and the driver unit 11 emitting the acoustic signal AC2 (second acoustic signal) in which the frequency band component including the predetermined frequency is not suppressed into the internal space of the hollow portion HP, when the resonance frequency f_{H} of the hollow portion HP becomes equal to or higher than the above-described predetermined frequency. In a case where the LPF unit 200 is switched to be used, the low-pass output signal via the LPF unit 200 is input to the driver unit 11, and the driver unit 11 is driven on the basis of the low-pass output signal. On the other hand, in a case where the LPF unit 200 is switched not to be used, the output signal output from the reproducing device 100 is directly input to the driver unit 11, and the driver unit 11 is driven on the basis of the output signal. The user may operate such a switching unit 210 by himself/herself. As a result, in an environment where the sound leakage needs to be cared, the acoustic signals AC1 and AC2 with the above-described frequency band components suppressed are emitted to suppress the sound leakage in a high frequency range, and in an environment where external noise is large and the sound leakage does not need to be cared, the acoustic signals AC1 and AC2 can be emitted without suppressing the above-described frequency band components. Note that the switching unit 210 may be provided outside the housing 12 or may be provided in the housing 12 itself.

### Third Embodiment

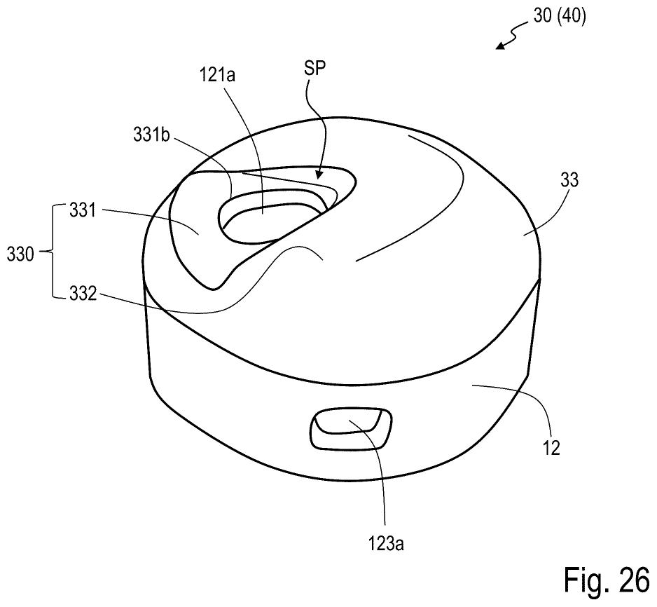

A third embodiment is a modification of the first embodiment. As illustrated in FIGS. 26 to 28B, an acoustic signal output device 30 of the present embodiment includes a driver unit 11, a housing 12 accommodating the driver unit 11 therein, and a support portion 33 arranged in an auricle of a user at the time of wearing.

<Sound Holes 121a and 123a>

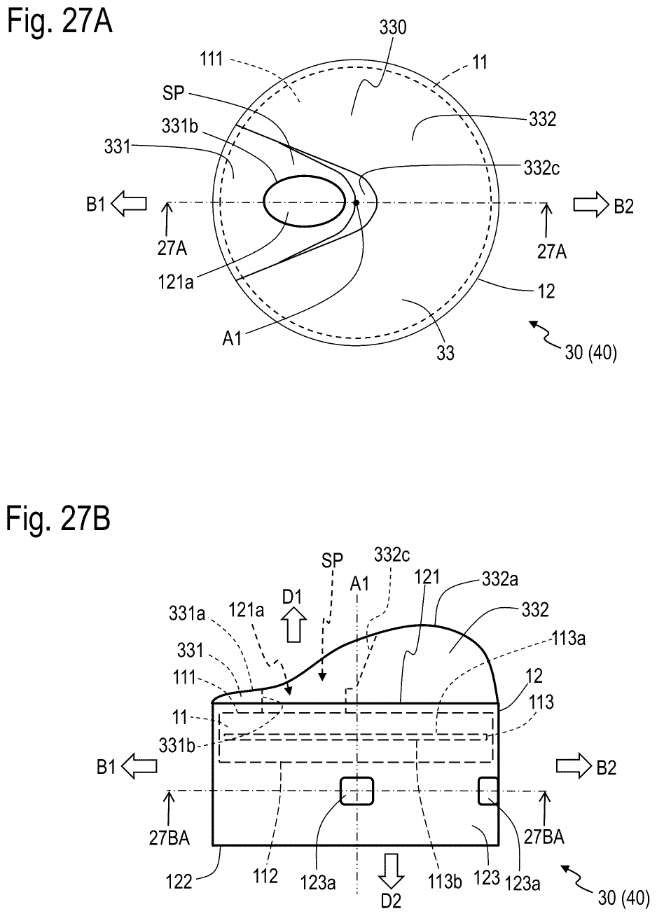

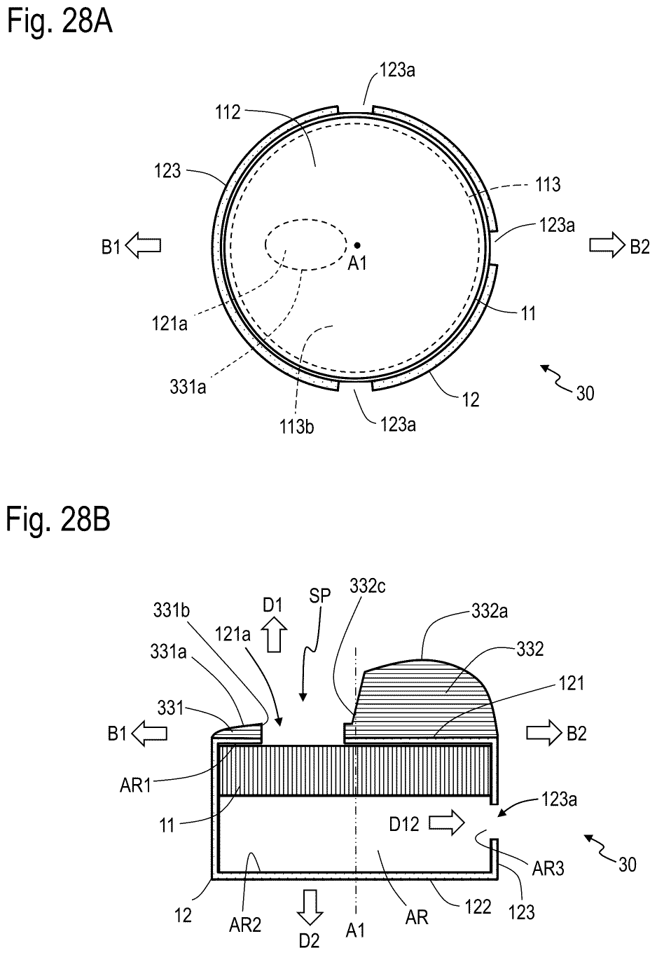

As illustrated in FIGS. 27A to 28B, and the like, a sound hole 121a (first sound hole) of the present embodiment is included in a region AR1 of a wall portion 121 arranged on one side (D1 direction side that is a side to which an acoustic signal AC1 is emitted) of the driver unit 11. The sound hole 121a of the present embodiment is arranged at an eccentric position shifted in a B1 direction from an axis A1 (a central axis of a structure unit), and is opened toward a D1 direction. The B1 direction is a specific radiation direction centered on the axis A1. In the present embodiment, for simplification of description, an example is described in which a shape of an edge of an open end of the sound hole 121a is an elliptical shape (the open end has an elliptical shape). Note that this does not limit the present invention. For example, the shape of the edge of the sound hole 121a may be another shape such as a circle, a quadrangle, or a triangle. Further, the end of sound hole 121a may have a mesh shape. In other words, the end of the sound hole 121a may be constituted by a plurality of holes. In the present embodiment, for simplification of description, an example is described in which one sound hole 121a is included in the region AR1 of the wall portion 121 of the housing 12. Note that this does not limit the present invention. For example, two or more sound holes 121a may be included in the region AR1 of the wall portion 121 of the housing 12.

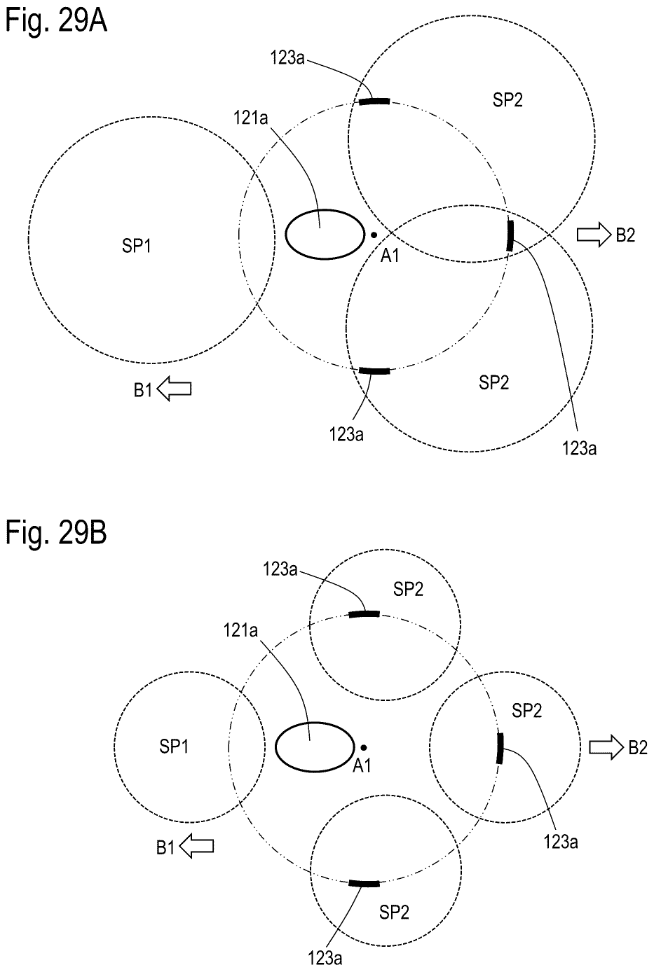

Sound holes 123a (second sound holes) of the present embodiment are arranged to be biased on a B2 direction side. The B2 direction is a direction including a reverse direction component of the B1 direction. For example, the sound hole 123a (second sound hole) is not provided on the B1 direction side of the axis A1. As illustrated in FIGS. 29A and 29B, in the case where the sound holes 123a (second sound holes) are arranged in this manner, a total area of opening ends of the sound holes 123a (second sound holes) facing a space SP1 is smaller than a total area of opening ends of the sound holes 123a (second sound holes) facing a space SP2. As a result, a sound pressure level of the acoustic signal AC2 (second acoustic signal) emitted from the sound hole 123a (second sound hole) into the space SP1 becomes lower than a sound pressure level of the acoustic signal AC2 (second acoustic signal) emitted from the sound hole 123a (second sound hole) into the space SP2. Note that the space SP1 is a space located on the B1 direction side with respect to the sound hole 121a (first sound hole), and the space SP2 is a space located on the B2 direction side with respect to the sound hole 121a (first sound hole). That is, for example, it is preferable to design such that more sound holes 123a are arranged as being farther from the position of the sound hole 121a in the housing 12, and less sound holes 123a are arranged as being closer to the position of the sound hole 121a in the housing 12.

### <Support Portion 33>

As illustrated in FIGS. 26, 27B, and 28B, the support portion 33 is a convex portion provided on an outer surface of the wall portion 121 on the D1 direction side of the housing 12. The support portion 33 is provided with an open end 331b of the sound hole 121a, and the acoustic signal AC1 emitted from the sound hole 121a is emitted to the outside from the open end 331b. For example, the open end 331b is a through hole, and emits the acoustic signal AC1 emitted from the sound hole 121a to the outside.

At least a part of an outer surface region 330 of the support portion 33 has a convex shape. The outer surface region 330 is a region on an outer surface side surrounding the opening end 331b of the sound hole 121a (first sound hole), and is, for example, an annular region located on the outer surface side on the D1 direction side of the support portion 33. The outer surface region 330 includes a region 331 and a region 332 further protruding than the region 331, and is configured in a shape that guides the acoustic signal AC1 (first acoustic signal) emitted from the sound hole 121a (first sound hole) to the region 331 side. The region 331 in this example is arranged on the B1 direction side of the region 332, and the outer surface region 330 guides the acoustic signal AC1 emitted from the sound hole 121a to the B1 direction side. For example, the opening end 331b of the sound hole 121a (first sound hole) faces a space SP surrounded by the region 332, and the region 331 side of the space SP is opened to an outside of an outer periphery of the space SP (an outside on the B1 direction side). That is, for example, the region 332 is a convex region having a surface 332a protruding more outward (D1 direction) than a surface 331a of the region 331, and surrounds a region other than the region 331 side (B1 direction side) in the region around the opening end 331b. In other words, for example, the region 331 is further recessed than the region 332, and the region 332 is curved so as to partially surround a periphery of the opening end 331b of the region 331. That is, the region 331 in this example is disposed on the B1 direction side of the opening end 331b of the sound hole 121a, and the region 332 is a region having a bulge so as to surround a range in a 360-degree radiation direction centered on the opening end 331b except for a part of the range on the B1 direction side. For example, the region 332 has a chevron shape having a maximum portion at one or more places. In addition, the surface 332a of the region 332 in this example is connected to the surface 331a of the region 331 via an inclined portion 332c of the region 332. That is, the inclined portion 332c in this example has a tapered shape expanding from the surface 331a to the surface 332a. In this case, when the acoustic signal output device 30 is worn, the acoustic signal AC1 emitted from the sound hole 121a can be efficiently guided to an ear canal side of the user arranged on the region 331 side (B1 direction side). However, the opening end 331b side of the region 332 may not be tapered. Further, the opening end of the sound hole 123a (second sound hole) faces a space outside the space SP surrounded by the region 332. More specifically, the opening end of the sound hole 123a (second sound hole) of the present embodiment faces a space outside the space surrounded by the outer surface region 330. In addition, as described above, the sound hole 123a (second sound hole) is arranged to be biased on the B2 direction side. As a result, the acoustic signal AC2 emitted from the sound hole 123a is less likely to reach a user's ear canal side than the acoustic signal AC1 emitted from the sound hole 121a.

Note that the illustrated shape of the support portion 33 is an example and does not limit the present invention. For example, the surface 331a of the region 331 and the surface 332a of the region 332 may have a convex shape, a concave shape, an uneven shape, or a flat shape as long as the surface 332a of the region 332 further protrudes in the D1 direction than the surface 331a of the region 331. Note that a fitting feeling at the time of wearing is better when the surface 332a of the region 332 has a curved convex shape. Further, the material of the support portion 33 is also not limited. The support portion 33 may be formed of a rigid body such as synthetic resin, or may be formed of an elastic body such as rubber or urethane. Note that a fitting feeling at the time of wearing is better when the region 332 is an elastic body.

### <Wearing State>

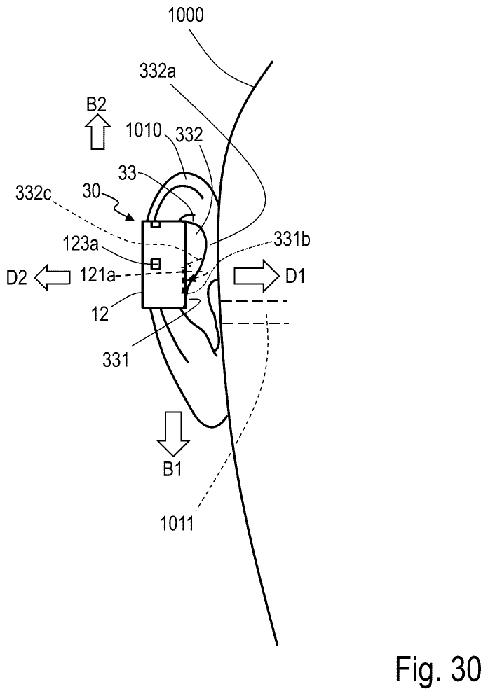

A wearing state of the acoustic signal output device 30 will be illustrated using FIG. 30. The acoustic signal output device 30 of the present embodiment is worn on an auricle 1010 (body) such that the support portion 33 side faces the auricle 1010 side of a user 1000. When the housing 12 and the support portion 33 are attached to the auricle 1010 of the user 1000 in this manner, the region 332 of the support portion 33 is supported in contact with any portion of the auricle 1010 (body), and the region 331 is arranged on the ear canal 1011 side without the opening end 331b of the sound hole 121a (first sound hole) and the region 331 of the support portion 33 contacting at least a part of the auricle 1010 (body). For example, when the acoustic signal output device 30 is worn, the region 332 is arranged on an upper side of the auricle 1010, and the surface 332a of the region 332 is supported in contact with an upper portion (for example, a triangular fossa, a scaphoid fossa, or the like) of the auricle 1010. As a result, it is possible to prevent the sound hole 121a from coming into contact with any portion of the auricle 1010 of the user 1000 and being blocked. In addition, since the region 331 comes into contact with the auricle 1010 and serves as a support, a sense of stability at the time of wearing is high. In particular, in a case where the region 331 has a convex shape, the region 331 fits the concave shape of the auricle 1010 and serves as a support, thereby increasing the sense of stability at the time of wearing. This effect is higher when the region 331 is an elastic body than when the region is a rigid body. When the acoustic signal output device 30 is worn, for example, the region 331 is arranged on a lower side than the region 332 (on the ear canal 1011 side). As described above, the outer surface region 330 of the support portion 33 is configured in a shape that guides the acoustic signal AC1 (first acoustic signal) emitted from the sound hole 121a (first sound hole) to the region 331 side (B1 direction side). Therefore, the acoustic signal AC1 emitted from the sound hole 121a is guided to the ear canal 1011 side (a lower side of the auricle 1010) and emitted. Since the region 332 supported by the auricle 1010 further protrudes than the region 331, the opening end 331b and at least a part of the region 331 do not contact the auricle 1010. Preferably, the opening end 331b and the region 331 do not contact the auricle 1010. Further, the support portion 33 does not block the ear canal 1011. As a result, the acoustic signal AC1 emitted from the sound hole 121a efficiently reaches the ear canal 1011. Furthermore, as described above, in the case where the inclined portion 332c of the support portion 33 has a tapered shape expanding from the surface 331a to the surface 332a, the acoustic signal AC1 emitted from the sound hole 121a more efficiently reaches the ear canal 1011. Meanwhile, since the B2 direction side of the opening end 331b of the sound hole 121a is surrounded by the region 332, it is possible to suppress leakage (sound leakage) of the acoustic signal AC1 emitted from the sound hole 121a to the B2 direction side. That is, when the housing 12 and the support portion 33 are attached to the auricle 1010 (body), the sound pressure level of the acoustic signal AC1 (first acoustic signal) emitted from the ear canal 1011 to the ear canal 1011 side becomes higher than the sound pressure level of the acoustic signal AC1 (first acoustic signal) emitted from a portion other than the ear canal 1011 to a portion other than the ear canal 1011 side.

Furthermore, the opening end of the sound hole 123a (second sound hole) of the present embodiment faces the space outside the space SP surrounded by the region 332. Further, the sound holes 123a (second sound holes) are arranged to be biased on the B2 direction side. As a result, the acoustic signal AC2 emitted from the sound hole 123a is less likely to reach the ear canal 1011 side of the user 1000 than the acoustic signal AC1 emitted from the sound hole 121a. As described above, the acoustic signal AC2 has a function to cancel the acoustic signal AC1 leaking to the outside and suppress the sound leakage. However, since the acoustic signal AC2 emitted from the sound hole 123a is less likely to reach the ear canal 1011 side of the user 1000 than the acoustic signal AC1 emitted from the sound hole 121a, the acoustic signal AC1 is less likely to be canceled by the acoustic signal AC2 on the ear canal 1011 side. That is, since the sound hole 123a is distant from the ear canal 1011, the acoustic signal AC2 emitted from the sound hole 123a less likely cancels the acoustic signal AC1 emitted from the sound hole 121a to the ear canal 1011 side. In other words, the acoustic signal AC2 can suppress the sound leakage of the acoustic signal AC1 leaking to a portion other than the ear canal 1011 side without suppressing the acoustic signal AC1 emitted to the side of the ear canal 1011 so much.

### Fourth Embodiment

The present embodiment is a mode in which the second embodiment is combined with the third embodiment. That is, in the present embodiment, at least one of S, V, or L in Formula (1) is mechanically changed in the third embodiment, whereby the resonance frequency f_{H} [Hz] based on the Helmholtz resonance of the housing 12 is changed.

### Configuration Example 4

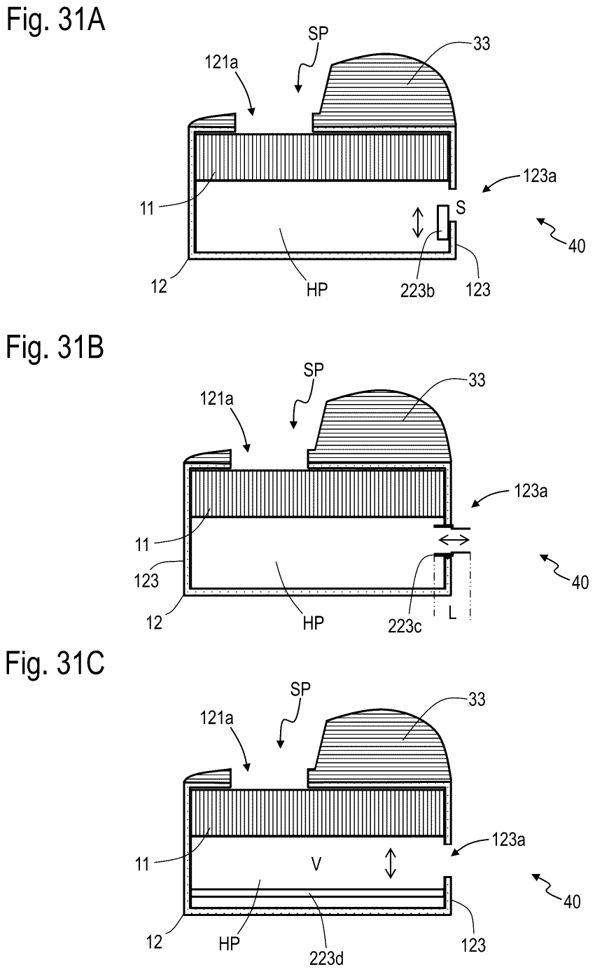

As illustrated in FIG. 31A, similarly to the configuration example 1 of the second embodiment, an acoustic signal output device 40 of a configuration example 4 of the present embodiment includes a driver unit 11, a housing 12 (structure unit) accommodating the driver unit 11, and provided with a single or a plurality of sound holes 121a (first sound holes) that emits an acoustic signal AC1 (first acoustic signal) emitted from a D1 direction side of the driver unit 11 to an outside, a hollow portion HP having an internal space into which an acoustic signal AC2 (second acoustic signal) emitted from a D2 direction side of the driver unit 11 is emitted, and a single or a plurality of sound holes 123a (second sound holes) that emits the acoustic signal AC2 (second acoustic signal) emitted to the internal space of the hollow portion HP to the outside, a single or a plurality of mechanism units 223b that changes an opening area of the sound hole 123a (second sound hole), and a support portion 33. An operation of the mechanism unit 223b is as described in the configuration example 1 of the second embodiment.

### Configuration Example 5

As illustrated in FIG. 31B, the acoustic signal output device 40 of the configuration example 5 of the present embodiment includes a single or a plurality of mechanism units 223c instead of the mechanism units 223b of the configuration example 4. An operation of the mechanism unit 223c is as described in the configuration example 2 of the second embodiment.

### Configuration Example 6

As illustrated in FIG. 31C, the acoustic signal output device 40 of the configuration example 6 of the present embodiment includes a single or a plurality of mechanism units 223d instead of the mechanism units 223b of the configuration example 4. An operation of the mechanism unit 223d is as described in the configuration example 3 of the second embodiment.

### Configuration Example 7

A configuration obtained by combining any of the configuration examples 4 to 6 of the present embodiment may be adopted. That is, the acoustic signal output device 40 may include any two or more types of the mechanism units 223b, 223c, and 223d.

### Configuration Example 8

Furthermore, in the fourth embodiment, similarly to the configuration example 5 of the second embodiment, when the resonance frequency f_{H} of the hollow portion HP becomes equal to or higher than the above-described predetermined frequency (for example, a band in which human auditory sensitivity is high, for example, 6 kHz) by controlling the mechanism units 223b, 223c, and 223d, the high-frequency side of the acoustic signal AC2 emitted from the sound hole 123a to the outside may be reduced. Further, a switching unit may be further provided, which switches between the driver unit 11 emitting the acoustic signal AC2 (second acoustic signal) in which a frequency band component including the above-described predetermined frequency is suppressed into the internal space of the hollow portion HP and the driver unit 11 emitting the acoustic signal AC2 (second acoustic signal) in which the frequency band component including the predetermined frequency is not suppressed into the internal space of the hollow portion HP, when the resonance frequency f_{H} of the hollow portion HP becomes equal to or higher than the above-described predetermined frequency. These specific examples are as described in the configuration example 5 of the second embodiment.

### Experiment Result

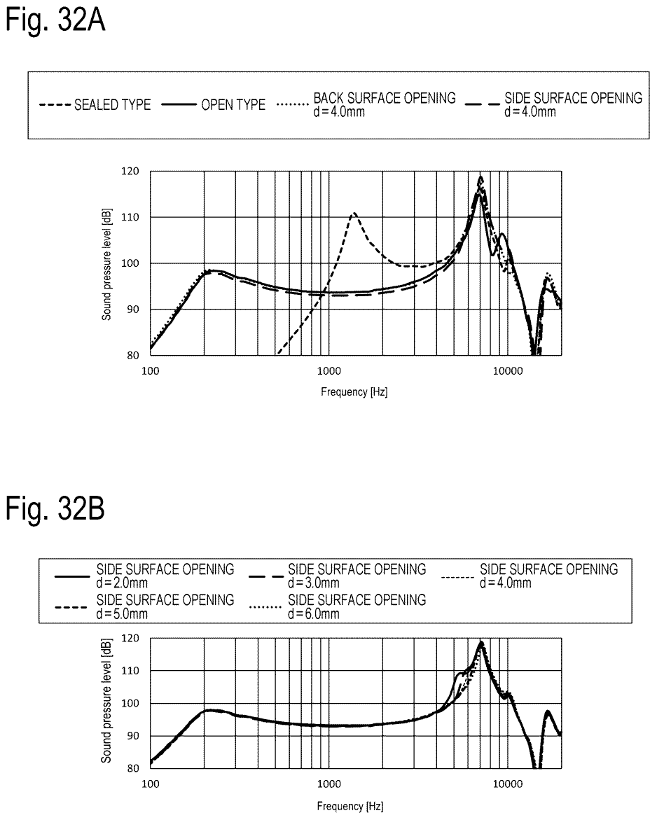

FIG. 32A illustrates frequency characteristics of an acoustic signal observed outside in a case where the sound hole 123a is completely closed by the mechanism unit 223b (sealed type), in a case where the driver unit 11 is not covered by the housing 12 (open type), in a case where the sound hole 123a (a sound hole having a rectangular edge with one side length of 3.5 mm and the other one side length of 4.0 mm) is provided in a wall portion 122 (back surface) of the housing 12 (back surface opening d=4.0 mm), and in a case where the sound hole 123a (a sound hole having an rectangular edge with one side length of 3.5 mm and the other one side length of 4.0 mm) is provided in a wall portion 123 (side surface) of the housing 12 (side surface opening d=4.0 mm). Here, the horizontal axis in FIG. 32A represents a frequency (Frequency [Hz]), and the vertical axis represents a sound pressure level (Sound pressure level (SPL) [dB]). As illustrated in this drawing, the sound pressure level at around 1.5 kHz can be increased by completely closing the sound hole 123a with the mechanism unit 223b.

Furthermore, FIG. 32B illustrates frequency characteristics of an acoustic signal observed outside in a case where the opening area of the sound hole 123a provided in the wall portion 123 (side surface) of the housing 12 is changed by the mechanism unit 223b. Here, the horizontal axis in FIG. 32B represents a frequency (Frequency [Hz]), and the vertical axis represents a sound pressure level (Sound pressure level (SPL) [dB]). In addition, “side opening d=aa mm” in the legend indicates frequency characteristics when the edge of the sound hole 123a is formed into a rectangle having one side length of 3.5 mm and the other one side length of aa mm by the mechanism unit 223b. As exemplified in this drawing, it can be seen that the frequency characteristics of the acoustic signal observed outside can be changed by changing the opening area of the sound hole 123a by the mechanism unit 223b.

### Fifth Embodiment

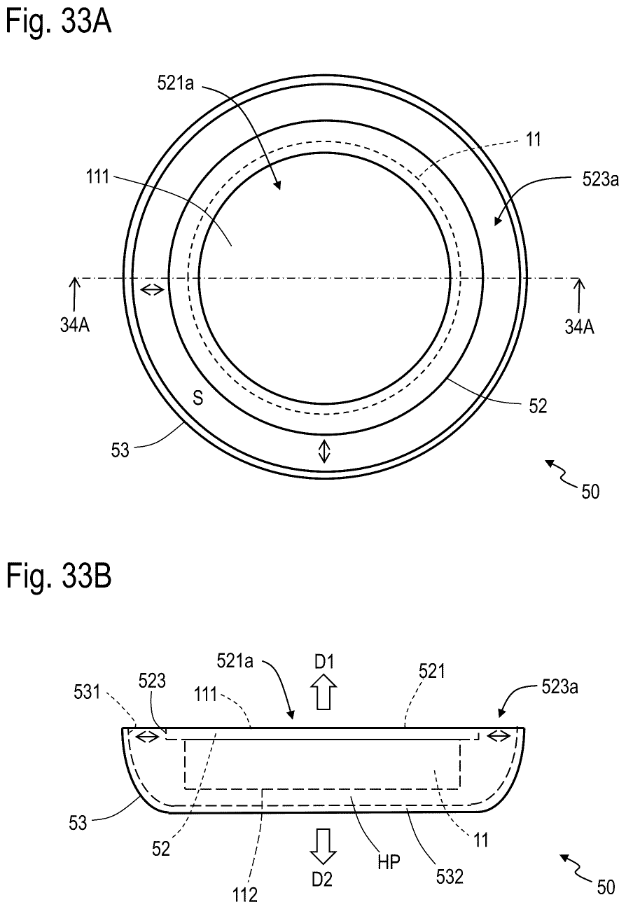

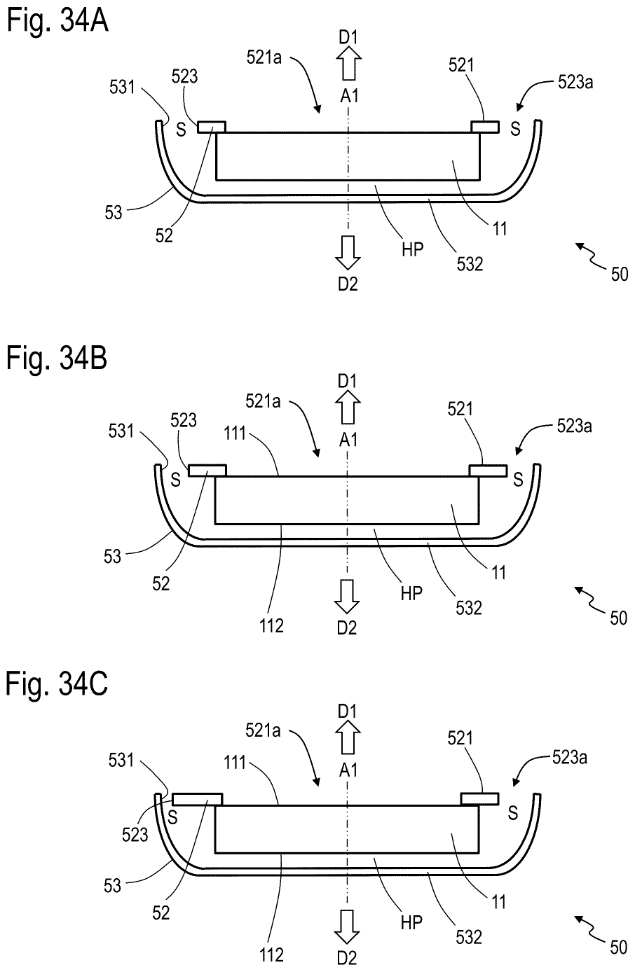

A fifth embodiment is a modification of the second embodiment and the fourth embodiment. As illustrated in FIGS. 33A to 34C, an acoustic signal output device 50 of the present embodiment includes a driver unit 11, a baffle unit 52 (mechanism unit), and a collar unit 53 (structure unit). The baffle unit 52 is a donut plate-shaped member having a sound hole 521a (first sound hole). The baffle unit 52 is attached to a peripheral edge portion of a surface 111 on a D1 direction side of the driver unit 11, and emits an acoustic signal AC1 emitted from the D1 direction side of the driver unit 11 to an outside from the sound hole 521a. The collar unit 53 is a hollow dish-shaped member, and accommodates the driver unit 11 therein. At this time, a surface 112 on a D2 side of the driver unit 11 faces a wall portion 532 on a bottom surface side inside the collar unit 53. A peripheral edge portion of the collar unit 53 extends toward the D1 side, and an end portion 531 thereof faces an outer peripheral portion 523 of the baffle unit 52. Here, a gap between the end portion 531 of the collar unit 53 and the outer peripheral portion 523 of the baffle unit 52 is a sound hole 523a. That is, an acoustic signal AC2 emitted from a D2 direction side of the driver unit 11 is emitted to a hollow portion HP of the baffle unit 52 and emitted from the sound hole 523a in the D1 direction. Here, as illustrated in FIGS. 34A to 34C, the baffle unit 52 (mechanism unit) is deformable, and the baffle unit 52 can change an opening area of the sound hole 523a by deformation. The opening area of the sound hole 523a may change axially symmetric or substantially axially symmetric with respect to an axis A1 as illustrated in FIGS. 34A and 34B, or may change asymmetrically with respect to the axis A1 as illustrated in FIG. 34C. Alternatively, the collar unit 53 (mechanism unit) may be deformable instead of the baffle unit 52. In this case, the opening area of the sound hole 523a may be changed by deforming the end portion 531 of the collar unit 53. Alternatively, the opening area of the sound hole 523a may be changed by deforming both the baffle unit 52 (mechanism unit) and the collar unit 53 (mechanism unit). Alternatively, the opening area of the sound hole 521a may be changed by deformation of the baffle unit 52. The movement and deformation of the baffle unit 52 and the collar unit 53 may be based on electromagnetic power or may be based on user's manual operation. As a result, a resonance frequency f based on Helmholtz resonance of the hollow portion HP can be changed. Furthermore, at least one of the baffle unit 52 or the collar unit 53 may be adaptively controlled according to an environment such as noise around the acoustic signal output device 50 and location information to change the resonance frequency f_{H} suitable for the environment.

That is, the acoustic signal output device 50 of the present embodiment includes the baffle unit 52 and the collar unit 53 (structure units) accommodating the driver unit 11, and provided with the single or the plurality of sound holes 121a (first sound holes) that emits the acoustic signal AC1 (first acoustic signal) emitted from a D1 direction side of the driver unit 11 to the outside, a hollow portion HP having the internal space into which the acoustic signal AC2 (second acoustic signal) emitted from a D2 direction side of the driver unit 11 is emitted, and the single or the plurality of sound holes 123a (second sound holes) that emits the acoustic signal AC2 (second acoustic signal) emitted to the internal space of the hollow portion HP to the outside, and the baffle unit 52 and/or the collar unit 53 (a single or a plurality of mechanism units) that changes the opening area of the sound hole 123a (second sound hole). Here, the sound hole 121a (first sound hole) emits the acoustic signal AC1 (first acoustic signal) to the D1 direction (specific direction) side, the internal space of the hollow portion HP guides the acoustic signal AC2 (second acoustic signal) to the D1 direction (specific direction) side, and the sound hole 123a (second sound hole) emits the guided acoustic signal AC2 (second acoustic signal) to the D1 direction (specific direction) side. The acoustic signal output device 50 may be of any type as long as the acoustic signal output device 50 has such a structure.

### Experiment Result

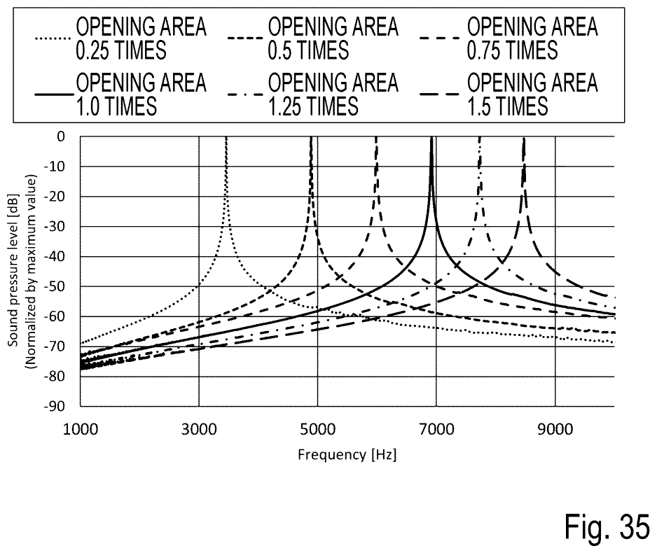

An experimental result indicating a sound leakage reduction effect by the acoustic signal output device 50 of the present embodiment is described. FIG. 35 illustrates frequency characteristics of an inside of the housing calculated on the basis of a volume, a neck length, and an opening area of the inside of the housing. Here, in FIG. 35, the horizontal axis represents the frequency (Frequency [Hz]), and the vertical axis represents the sound pressure level (SPL) [dB] normalized by a maximum value. In addition, “the opening area aaa times” in the legend represents frequency characteristics in a case where the opening area of the sound hole 523a is aaa times the opening area as a reference. As illustrated in this drawing, it can be seen that the resonance frequency f_{H} based on the Helmholtz resonance of the hollow portion HP can be changed by changing the opening area of the sound hole 523a, and the frequency characteristics of the acoustic signal emitted to the outside can be changed. Furthermore, it can also be seen that the larger the opening area of the sound hole 523a, the higher the resonance frequency f_{H} can be, and the higher the maximum frequency of the acoustic signal emitted to the outside can be.

### [Modification 1 of Fifth Embodiment]

At least one (mechanism unit) of the baffle unit 52 or the collar unit 53 may be deformed in a D1-D2 direction. Thus, a length L from the internal space of the hollow portion HP to the opening end of each sound hole 123a may be changed. Alternatively, the above-described mechanism unit 223d may be provided in the internal space of the hollow portion HP, and a volume V of the internal space of the hollow portion HP may be changed by the mechanism unit 223d. By these configurations, the resonance frequency f_{H} based on the Helmholtz resonance of the hollow portion HP can be changed.

### [Modification 2 of Fifth Embodiment]

Furthermore, in the fifth embodiment, similarly to the configuration example 5 of the second embodiment, when the resonance frequency f_{H} of the hollow portion HP becomes equal to or higher than the above-described predetermined frequency (for example, a band in which human auditory sensitivity is high, for example, 6 kHz), the high-frequency side of the acoustic signal AC2 emitted from the sound hole 123a to the outside may be reduced. Further, a switching unit may be further provided, which switches between the driver unit 11 emitting the acoustic signal AC2 (second acoustic signal) in which a frequency band component including the above-described predetermined frequency is suppressed into the internal space of the hollow portion HP and the driver unit 11 emitting the acoustic signal AC2 (second acoustic signal) in which the frequency band component including the predetermined frequency is not suppressed into the internal space of the hollow portion HP, when the resonance frequency f_{H} of the hollow portion HP becomes equal to or higher than the above-described predetermined frequency. These specific examples are as described in the configuration example 5 of the second embodiment.

### [Other Modifications and Like]

Note that the present invention is not limited to the above-described embodiments. For example, in each of the embodiments and the modifications thereof, the driver unit 11 may be disposed outside the housing 12 or the collar unit 53 instead of being accommodated inside the housing 12 or the collar unit 53. In this case, each of the acoustic signals AC1 and AC2 emitted from the driver unit 11 is introduced into the housing 12 and the collar unit 53 through the waveguide. As a result, the size of the driver unit 11 can be increased without increasing the size and weight of the housing 12 and the collar unit 53.

### REFERENCE SIGNS LIST

10, 20, 30, 40, 50 Acoustic signal output device
11 Driver unit
12 Housing
33 Support portion
52 Baffle unit
53 Collar unit
223b, 223c, 223d Mechanism unit
121a, 123a, 521a, 523a Sound hole

1. An acoustic signal output device comprising:
a structure provided with a single or a plurality of first sound holes that emits a first acoustic signal to an outside, a hollow portion having an internal space into which a second acoustic signal is emitted, and a single or a plurality of second sound holes that emits the second acoustic signal emitted to the internal space of the hollow portion to the outside; and
a single or a plurality of mechanism configured to change at least one of an opening area of the first sound hole or the second sound hole, a length from the internal space of the hollow portion to an opening end of the first sound hole or the second sound hole, or a volume of the internal space of the hollow portion, wherein,
an attenuation rate of the first acoustic signal at a second point with reference to a predetermined first point where the first acoustic signal arrives, the second point being farther from the acoustic signal output device than the first point, in a case where the first acoustic signal is emitted from the first sound hole and the second acoustic signal is emitted from the second sound hole,
is designed to be equal to or less than
a predetermined value smaller than an attenuation rate due to air propagation of an acoustic signal at the second point with reference to the first point, or
an attenuation amount of the first acoustic signal at the second point with reference to the first point
is designed to be equal to or larger than
a predetermined value larger than an attenuation amount due to air propagation of an acoustic signal at the second point with reference to the first point.

2. The acoustic signal output device according to claim 1, wherein
a resonance frequency of the hollow portion is designed to be able to be changed by the mechanism changing at least one of the opening area of the first sound hole or the second sound hole, the length from the internal space of the hollow portion to the opening end of the first sound hole or the second sound hole, or the volume of the internal space of the hollow portion.

3. The acoustic signal output device according to claim 1, wherein
the second acoustic signal in which a frequency band component including a predetermined frequency is suppressed is designed to be emitted from the second sound hole to the outside when a resonance frequency of the hollow portion becomes equal to or higher than the predetermined frequency.

4. The acoustic signal output device according to claim 3, further comprising:
a driver configured to emit the second acoustic signal in which a frequency band component including the predetermined frequency is suppressed into the internal space of the hollow portion when the resonance frequency of the hollow portion becomes equal to or higher than the predetermined frequency.

5. The acoustic signal output device according to claim 4, further comprising:
a switch configured to switch between the driver emitting the second acoustic signal in which the frequency band component including the predetermined frequency is suppressed into the internal space of the hollow portion, and the driver emitting the second acoustic signal in which the frequency band component including the predetermined frequency is not suppressed into the internal space of the hollow portion, when the resonance frequency of the hollow portion becomes equal to or higher than the predetermined frequency.

6. The acoustic signal output device according to claim 1, wherein
the second sound hole is able to be opened and closed by the mechanism, and
a sound pressure at a specific position of the first acoustic signal emitted from the first sound hole when the second sound hole is closed is higher than a sound pressure at the specific position of the first acoustic signal emitted from the first sound hole when the second sound hole is opened.

7. The acoustic signal output device according to claim 1, wherein
the first sound hole emits the first acoustic signal to a specific direction side,
the internal space of the hollow portion guides the second acoustic signal to the specific direction side, and
the second sound hole emits the guided second acoustic signal to the specific direction side.
